(19) United States
(12) Patent Application Publication
(10) Pub. No.: US 2025/0109795 A1
(43) Pub. Date: Apr. 3, 2025

(54) MULTILAYER GASKET AND METHODS OF FORMING THE SAME

(71) Applicant: SAINT-GOBAIN PERFORMANCE PLASTICS CORPORATION, Solon, OH (US)

(72) Inventors: David A. RICH, Nashua, NH (US); Joseph G. SARGENT, Lowell, MA (US)

(21) Appl. No.: 18/897,039

(22) Filed: Sep. 26, 2024

Related U.S. Application Data
(60) Provisional application No. 63/586,041, filed on Sep. 28, 2023.

(51) Int. Cl. F16J 15/10

(52) U.S. Cl. CPC F16J 15/102

(57) ABSTRACT

The present disclosure relates to a multilayer gasket that may include a core layer, and a first outer layer overlying a first surface of the core layer. The first outer layer may include a low-melt fluoropolymer material having a melting temperature of not greater than about 300° C.

### CROSS-REFERENCE TO RELATED APPLICATION(S)

This application claims priority under 35 U.S.C. § 119 (e) to U.S. Provisional Patent Application No. 63/586,041, entitled “MULTILAYER GASKET AND METHODS OF FORMING THE SAME,” filed Sep. 28, 2023, by David A. RICH et al., which is assigned to the current assignee hereof and is incorporated by reference herein in its entirety.

### FIELD OF THE DISCLOSURE

The present disclosure relates to a multilayer gasket and, in particular, a multilayer electrolyzer gasket for use in an electrolyzer membrane electrode assembly. The present disclosure further relates to an electrolyzer membrane electrode assembly that includes the multilayer gasket.

### BACKGROUND

A proton exchange membrane (PEM) electrolyzer cell generally includes an electrolyte that is a thin, solid, ion-conducting membrane along with an anode and cathode. Preventing electrolyte leakage or gas leakage from an electrolyzer cell requires the use of gaskets. Such gaskets need to be chemically stable enough to survive the PEM electrolyzer cell environment as well as thermally stable enough to survive the assembly process. Accordingly, gasket materials and designs that can be used in a PEM electrolyzer, are thermally stable, and are capable of ensuring a sufficiently strong seal during use in the PEM electrolyzer are desired.

### SUMMARY

According to a first aspect, a multilayer gasket may include a core layer, and a first outer layer overlying a first surface of the core layer. The first outer layer may include a low-melt fluoropolymer material having a melting temperature of not greater than about 300° C.

According to another aspect, a multilayer gasket may include a core layer, and a first outer layer overlying a first surface of the core layer. The first outer layer may include a low-melt fluoropolymer material comprising polyvinylidene fluoride (PVDF) or terpolymer of tetrafluorethylene hexafluorpropylene) or vinylidene fluoride (THV) or ethylene tetrafluoroethylene (ETFE) or ethylene chlorotrifluoroethylene (ECTFE) or fluorinated ethylene propylene (FEP) or perfluoroalkoxy alkane (PFA) or any combination thereof or copolymers thereof.

According to yet another aspect, an electrolyzer membrane electrode assembly (MEA) may include a membrane, an anode, a cathode, and a multilayer gasket. The multilayer gasket may include a core layer, and a first outer layer overlying a first surface of the core layer. The first outer layer may include a low-melt fluoropolymer material having a melting temperature of not greater than about 300° C.

According to yet another aspect, an electrolyzer membrane electrode assembly (MEA) may include a membrane, an anode, a cathode, and a multilayer gasket. The multilayer gasket may include a core layer, and a first outer layer overlying a first surface of the core layer. The first outer layer may include a low-melt fluoropolymer material comprising polyvinylidene fluoride (PVDF) or terpolymer of tetrafluorethylene hexafluorpropylene) or vinylidene fluoride (THV) or ethylene tetrafluoroethylene (ETFE) or ethylene chlorotrifluoroethylene (ECTFE) or fluorinated ethylene propylene (FEP) or perfluoroalkoxy alkane (PFA) or any combination thereof or copolymers thereof.

According to yet another aspect, a method of forming a multilayer gasket may include providing a core layer, and forming a first outer layer overlying a first surface of the core layer. The first outer layer may include a low-melt fluoropolymer material having a melting temperature of not greater than about 300° C.

According to still another aspect, a method of forming a multilayer gasket may include providing a core layer, and forming a first outer layer overlying a first surface of the core layer. The outer layer may include a low-melt fluoropolymer material comprising polyvinylidene fluoride (PVDF) or terpolymer of tetrafluorethylene hexafluorpropylene) or vinylidene fluoride (THV) or ethylene tetrafluoroethylene (ETFE) or ethylene chlorotrifluoroethylene (ECTFE) or fluorinated ethylene propylene (FEP) or perfluoroalkoxy alkane (PFA) or any combination thereof or copolymers thereof.

### BRIEF DESCRIPTION OF THE DRAWINGS

Embodiments are illustrated by way of example and are not limited to the accompanying figures.

FIG. 1 includes an illustration of a multilayer gasket configuration according to embodiments described herein,

FIG. 2 includes an illustration of a multilayer gasket configuration according to embodiments described herein,

FIG. 3 includes an illustration of an electrolyzer membrane electrode assembly (MEA) configuration according to embodiments described herein,

FIG. 4 includes a diagram showing a multilayer gasket forming method according to embodiments described herein, and

FIG. 5 includes a diagram showing a multilayer gasket forming method according to embodiments described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a multilayer gasket. According to certain embodiments, the multilayer gasket may include a core layer, and a first outer layer overlying a first surface of the core layer. According to still other embodiments, the first outer layer may include a low-melt fluoropolymer material having a melting temperature of not greater than about 300° C.

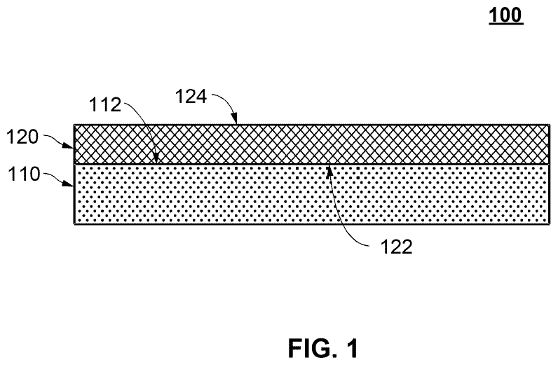

For purposes of illustration, FIG. 1 includes an illustration of multilayer gasket 100 according to embodiments described herein. As shown in FIG. 1, a multilayer gasket 100 may include a core layer 110, and a first outer layer 120 overlying a first surface 112 of the core layer 110. As further shown in FIG. 1, the first outer layer 120 may have an inner surface 122 adjacent to the first surface 112 of the core layer 110, and the first outer layer 120 may have an outer surface 124 opposite to the first surface 112 of the core layer 110.

According to particular embodiments, the first outer layer 120 may include a low-melt fluoropolymer material.

According to still other embodiments, the low-melt fluoropolymer material may have a particular melting temperature as measured using differential scanning calorimetry (DSC) according to ASTM D4591. For example, the low-melt fluoropolymer material may have a melting temperature of at least about 50° C., such as, at least about 55° C. or at least about 60° C. or at least about 65° C. or at least about 70° C. or at least about 75° C. or at least about 80° C. or at least about 85° C. or at least about 90° C. or at least about 95° C. or even at least about 100° C. According to still other embodiments, the low-melt fluoropolymer material may have a melting temperature of not greater than about 300° C., such as, not greater than about 290° C. or not greater than about 280° C. or not greater than about 270° C. or not greater than about 260° C. or not greater than about 250° C. not greater than about 240° C. or not greater than about 230° C. or not greater than about 220° C. or not greater than about 210° C. or not greater than about 200° C. or not greater than about 175° C. or not greater than about 150° C. or even not greater than about 125° C. It will be appreciated that the melting temperature of the low-melt fluoropolymer material may be within a range between any of the minimum and maximum values noted above. It will be further appreciated that the melting temperature of the low-melt fluoropolymer material may be any value between any of the minimum and maximum values noted above.

According to yet other embodiments, the low-melt fluoropolymer material may include a particular material. For example, the low-melt fluoropolymer material may include polyvinylidene fluoride (PVDF). According to still other embodiments, the low-melt fluoropolymer material may include a terpolymer of tetrafluoroethylene, hexafluoropropylene and vinylidene fluoride (THV). According to still other embodiments, the low-melt fluoropolymer material may include ethylene tetrafluoroethylene (ETFE). According to still other embodiments, the low-melt fluoropolymer material may include ethylene chlorotrifluoroethylene (ECTFE). According to still other embodiments, the low-melt fluoropolymer material may include a PVDF-HFP co-polymer. According to still other embodiments, the low-melt fluoropolymer material may include a mixture of PVDF and PTFE (PVDF/PTFE mixture). According to still other embodiments, the low-melt fluoropolymer material may include any combination of PVDF, THV, ETFE, ECTFE, PVDF-HFP co-polymer or PVDF/PTFE mixture.

According to yet other embodiments, the low-melt fluoropolymer material may consist of a particular material. For example, the low-melt fluoropolymer material may consist of polyvinylidene fluoride (PVDF). According to still other embodiments, the low-melt fluoropolymer material may consist of a terpolymer of tetrafluoroethylene, hexafluoropropylene and vinylidene fluoride (THV). According to still other embodiments, the low-melt fluoropolymer material may consist of ethylene tetrafluoroethylene (ETFE). According to still other embodiments, the low-melt fluoropolymer material may consist of ethylene chlorotrifluoroethylene (ECTFE). According to still other embodiments, the low-melt fluoropolymer material may consist of a PVDF-HFP co-polymer. According to still other embodiments, the low-melt fluoropolymer material may consist of a mixture of PVDF and PTFE (PVDF/PTFE mixture). According to still other embodiments, the low-melt fluoropolymer material may consist of any combination of PVDF, THV, ETFE, ECTFE, PVDF-HFP co-polymer or PVDF/PTFE mixture.

According to yet other embodiments, the low-melt fluoropolymer material may be a layer of a particular material. For example, the low-melt fluoropolymer material may be a polyvinylidene fluoride (PVDF) layer. According to still other embodiments, the low-melt fluoropolymer material may be a terpolymer of tetrafluoroethylene, hexafluoropropylene and vinylidene fluoride (THV) layer. According to still other embodiments, the low-melt fluoropolymer material may be an ethylene tetrafluoroethylene (ETFE) layer. According to still other embodiments, the low-melt fluoropolymer material may be an ethylene chlorotrifluoroethylene (ECTFE) layer. According to still other embodiments, the low-melt fluoropolymer material may be a PVDF-HFP co-polymer layer. According to still other embodiments, the low-melt fluoropolymer material may be a layer of a mixture of PVDF and PTFE (PVDF/PTFE mixture). According to still other embodiments, the low-melt fluoropolymer material may be a layer of any combination of PVDF, THV, ETFE, ECTFE, PVDF-HFP co-polymer or PVDF/PTFE mixture.

According to still other embodiments, the low-melt fluoropolymer material may include a particular content of fluoropolymer. For example, the low-melt fluoropolymer material may have a fluoropolymer content of at least about 50 wt. % for a total weight of the low-melt fluoropolymer material, such as, at least about 55 wt. % or at least about 60 wt. % or at least about 65 wt. % or at least about 70 wt. % or even at least about 75 wt. %. According to still other embodiments, the low-melt fluoropolymer material may have a fluoropolymer content of not greater than about 100 wt. % for a total weight of the low-melt fluoropolymer material, such as, not greater than about 99 wt. % or not greater than about 98 wt. % or not greater than about 97 wt. % or not greater than about 96 wt. % or not greater than about 95 wt. % or not greater than about 90 wt. % or not greater than about 85 wt. % or not greater than about 80 wt. % or even not greater than about 77 wt. %. It will be appreciated that the fluoropolymer content of the low-melt fluoropolymer material may be within a range between any of the minimum and maximum values noted above. It will be further appreciated that the fluoropolymer content of the low-melt fluoropolymer material may be any value between any of the minimum and maximum values noted above.

According to still other embodiments, the low-melt fluoropolymer material may include a particular content of PVDF. For example, the low-melt fluoropolymer material may have a PVDF content of at least about 50 wt. % for a total weight of the low-melt fluoropolymer material, such as, at least about 55 wt. % or at least about 60 wt. % or at least about 65 wt. % or at least about 70 wt. % or even at least about 75 wt. %. According to still other embodiments, the low-melt fluoropolymer material may have a PVDF content of not greater than about 100 wt. % for a total weight of the low-melt fluoropolymer material, such as, not greater than about 99 wt. % or not greater than about 98 wt. % or not greater than about 97 wt. % or not greater than about 96 wt. % or not greater than about 95 wt. % or not greater than about 90 wt. % or not greater than about 85 wt. % or not greater than about 80 wt. % or even not greater than about 77 wt. %. It will be appreciated that the PVDF content of the low-melt fluoropolymer material may be within a range between any of the minimum and maximum values noted above. It will be further appreciated that the PVDF content of the low-melt fluoropolymer material may be any value between any of the minimum and maximum values noted above.

According to still other embodiments, the low-melt fluoropolymer material may include a particular content of PVDF-HFP copolymer. For example, the low-melt fluoropolymer material may have a PVDF-HFP copolymer content of at least about 50 wt. % for a total weight of the low-melt fluoropolymer material, such as, at least about 55 wt. % or at least about 60 wt. % or at least about 65 wt. % or at least about 70 wt. % or even at least about 75 wt. %. According to still other embodiments, the low-melt fluoropolymer material may have a PVDF-HFP copolymer content of not greater than about 100 wt. % for a total weight of the low-melt fluoropolymer material, such as, not greater than about 99 wt. % or not greater than about 98 wt. % or not greater than about 97 wt. % or not greater than about 96 wt. % or not greater than about 95 wt. % or not greater than about 90 wt. % or not greater than about 85 wt. % or not greater than about 80 wt. % or even not greater than about 77 wt. %. It will be appreciated that the PVDF-HFP copolymer content of the low-melt fluoropolymer material may be within a range between any of the minimum and maximum values noted above. It will be further appreciated that the PVDF-HFP copolymer content of the low-melt fluoropolymer material may be any value between any of the minimum and maximum values noted above.

According to still other embodiments, the first outer layer 120 may include a particular content of fluoropolymer. For example, the first outer layer 120 may have a fluoropolymer content of at least about 50 wt. % for a total weight of the first outer layer 120, such as, at least about 55 wt. % or at least about 60 wt. % or at least about 65 wt. % or at least about 70 wt. % or even at least about 75 wt. %. According to still other embodiments, the first outer layer 120 may have a fluoropolymer content of not greater than about 100 wt. % for a total weight of the first outer layer 120, such as, not greater than about 99 wt. % or not greater than about 98 wt. % or not greater than about 97 wt. % or not greater than about 96 wt. % or not greater than about 95 wt. % or not greater than about 90 wt. % or not greater than about 85 wt. % or not greater than about 80 wt. % or even not greater than about 77 wt. %. It will be appreciated that the fluoropolymer content of the first outer layer 120 may be within a range between any of the minimum and maximum values noted above. It will be further appreciated that the fluoropolymer content of the first outer layer 120 may be any value between any of the minimum and maximum values noted above.

According to still other embodiments, the first outer layer 120 may include a particular content of PVDF. For example, the first outer layer 120 may have a PVDF content of at least about 50 wt. % for a total weight of the first outer layer 120, such as, at least about 55 wt. % or at least about 60 wt. % or at least about 65 wt. % or at least about 70 wt. % or even at least about 75 wt. %. According to still other embodiments, the first outer layer 120 may have a PVDF content of not greater than about 100 wt. % for a total weight of the first outer layer 120, such as, not greater than about 99 wt. % or not greater than about 98 wt. % or not greater than about 97 wt. % or not greater than about 96 wt. % or not greater than about 95 wt. % or not greater than about 90 wt. % or not greater than about 85 wt. % or not greater than about 80 wt. % or even not greater than about 77 wt. %. It will be appreciated that the PVDF content of the first outer layer 120 may be within a range between any of the minimum and maximum values noted above. It will be further appreciated that the PVDF content of the first outer layer 120 may be any value between any of the minimum and maximum values noted above.

According to still other embodiments, the first outer layer 120 may include a particular content of PVDF-HFP copolymer. For example, the first outer layer 120 may have a PVDF-HFP copolymer content of at least about 50 wt. % for a total weight of the first outer layer 120, such as, at least about 55 wt. % or at least about 60 wt. % or at least about 65 wt. % or at least about 70 wt. % or even at least about 75 wt. %. According to still other embodiments, the first outer layer 120 may have a PVDF-HFP copolymer content of not greater than about 100 wt. % for a total weight of the first outer layer 120, such as, not greater than about 99 wt. % or not greater than about 98 wt. % or not greater than about 97 wt. % or not greater than about 96 wt. % or not greater than about 95 wt. % or not greater than about 90 wt. % or not greater than about 85 wt. % or not greater than about 80 wt. % or even not greater than about 77 wt. %. It will be appreciated that the PVDF-HFP copolymer content of the first outer layer 120 may be within a range between any of the minimum and maximum values noted above. It will be further appreciated that the PVDF-HFP copolymer content of the first outer layer 120 may be any value between any of the minimum and maximum values noted above.

According to still other embodiments, the PVDF-HFP co-polymer may include a particular content of HFP. For example, PVDF-HFP co-polymer may have an HFP content of at least about 0.5 wt. % for a total weight of the PVDF-HFP co-polymer, such as, at least about 1 wt. % or at least about 5 wt. % or at least about 10 wt. % or at least about 15 wt. % or at least about 20 wt. % or even at least about 25 wt. %. According to still other embodiments, the PVDF-HFP co-polymer may have an HFP content of not greater than about 50 wt. % for a total weight of the PVDF-HFP co-polymer, such as, not greater than about 45 wt. % or not greater than about 40 wt. % or not greater than about 35 wt. % or even not greater than about 30 wt. %. It will be appreciated that the HFP content of the PVDF-HFP co-polymer may be within a range between any of the minimum and maximum values noted above. It will be further appreciated that the HFP content of the PVDF-HFP co-polymer may be any value between any of the minimum and maximum values noted above.

According to still other embodiments, the PVDF-HFP co-polymer may include a particular content of PVDF. For example, PVDF-HFP co-polymer may have a PVDF content of at least about 50 wt. % for a total weight of the PVDF-HFP co-polymer, such as, at least about 55 wt. % or at least about 60 wt. % or at least about 65 wt. % or at least about 70 wt. % or even at least about 75 wt. %. According to still other embodiments, the PVDF-HFP co-polymer may have a PVDF content of not greater than about 100 wt. % for a total weight of the PVDF-HFP co-polymer, such as, not greater than about 95 wt. % or not greater than about 90 wt. % or not greater than about 85 wt. % or even not greater than about 80 wt. %. It will be appreciated that the PVDF content of the PVDF-HFP co-polymer may be within a range between any of the minimum and maximum values noted above. It will be further appreciated that the PVDF content of the PVDF-HFP co-polymer may be any value between any of the minimum and maximum values noted above.

According to still other embodiments, the outer surface 124 of the first outer layer 120 may have a particular surface roughness when measured using a long wavelength cutoff of 800 (as defined in ASME B46.1) as measured according to ASTM D4417. For example, the outer surface 124 of the first outer layer 120 may have a surface roughness of at least about 0.01 microns, such as, at least about 0.05 microns or at least about 0.1 microns or at least about 0.5 microns or at least about 0.7 microns or at least about 1.0 microns or at least about 1.2 microns or at least about 1.5 microns or at least about 1.7 microns or at least about 2.0 microns or even at least about 2.2 microns. According to still other embodiments, the outer surface 124 of the first outer layer 120 may have a surface roughness of not greater than about 5.0 microns, such as, not greater than about 4.7 microns or not greater than about 4.5 microns or not greater than about 4.2 microns or not greater than about 4.0 microns or not greater than about 3.7 microns or not greater than about 3.5 microns or not greater than about 3.2 microns or not greater than about 3.0 microns or even not greater than about 2.7 microns. It will be appreciated that the outer surface 124 of the first outer layer 120 may have a surface roughness within a range between any of the minimum and maximum values noted above. It will be further appreciated that the outer surface 124 of the first outer layer 120 may have a surface roughness of any value between any of the minimum and maximum values noted above.

According to particular embodiments, the inner surface 122 of the first outer layer 120 may be a corona treated surface. According to other embodiments, the inner surface 122 of the first outer layer 120 may be a plasma treated surface. According to yet other embodiments, the inner surface 122 of the first outer layer 120 may be any combination of a corona treated surface and a plasma treated surface.

According to other embodiments, the outer surface 124 of the first outer layer 120 may be a corona treated surface. According to other embodiments, the outer surface 124 of the first outer layer 120 may be a plasma treated surface. According to yet other embodiments, the outer surface 124 of the first outer layer 120 may be any combination of a corona treated surface and a plasma treated surface.

According to still other embodiments, the inner surface 122 and the outer surface 124 of the first outer layer 120 may both be a corona treated surface. According to other embodiments, the inner surface 122 and the outer surface 124 of the first outer layer 120 may both be a plasma treated surface. According to yet other embodiments, the inner surface 122 and the outer surface 124 of the first outer layer 120 may both be any combination of a corona treated surface and a plasma treated surface.

According to still other embodiments, the outer surface 124 of the first outer layer 120 may have a particular adhesion strength as measured according to ASTM D1876. For example, the outer surface 124 of the first outer layer 120 may have an adhesion strength of at least about 0.1 lb./in, such as, at least about 0.5 lb./in or at least about 1.0 lb./in or at least about 1.5 lb./in or at least about 2.0 lb./in or at least about 2.5 lb./in or at least about 3.0 lb./in or at least about 3.5 lb./in or at least about 4.0 lb./in or even at least about 4.5 lb./in. According to still other embodiments, the outer surface 124 of the first outer layer 120 may have an adhesion strength of not greater than about 10 lb./in, such as, not greater than about 9.5 lb./in or not greater than about 9.0 lb./in or not greater than about 8.5 lb./in or not greater than about 8.0 lb./in or not greater than about 7.5 lb./in or not greater than about 7.0 lb./in or not greater than about 6.5 lb./in or not greater than about 6.0 lb./in or even not greater than about 5.5 lb./in. It will be appreciated that the outer surface 124 of the first outer layer 120 may have an adhesion strength within a range between any of the minimum and maximum values noted above. It will be further appreciated that the outer surface 124 of the first outer layer 120 may have an adhesion strength of any value between any of the minimum and maximum values noted above.

According to still other embodiments, the outer surface 124 of the first outer layer 120 may have a particular surface energy as measured according to ASTM D7490. For example, the outer surface 124 of the first outer layer 120 may have a surface energy of at least about 1.0 mJ/m², such as, at least about 5 mJ/m² or at least about 10 mJ/m² or at least about 15 mJ/m² or at least about 20 mJ/m² or at least about 25 mJ/m² or at least about 30 mJ/m² or at least about 35 mJ/m² or at least about 40 mJ/m² or even at least about 45 mJ/m². According to still other embodiments, the outer surface 124 of the first outer layer 120 may have a surface energy of not greater than about 100 mJ/m², such as, not greater than about 95 mJ/m² or not greater than about 90 mJ/m² or not greater than about 85 mJ/m² or not greater than about 80 mJ/m² or not greater than about 75 mJ/m² or not greater than about 70 mJ/m² or not greater than about 65 mJ/m² or not greater than about 60 mJ/m² or even not greater than about 55 mJ/m². It will be appreciated that the outer surface 124 of the first outer layer 120 may have a surface energy within a range between any of the minimum and maximum values noted above. It will be further appreciated that the outer surface 124 of the first outer layer 120 may have a surface energy of any value between any of the minimum and maximum values noted above.

According to still other embodiments, the outer surface 124 of the first outer layer 120 may have a particular water contact angle as measured according to ASTM D5946. For example, the outer surface 124 of the first outer layer 120 may have a water contact angle of at least about 1.0 degrees, such as, at least about 5 degrees or at least about 10 degrees or at least about 15 degrees or at least about 20 degrees or at least about 25 degrees or at least about 30 degrees or at least about 35 degrees or at least about 40 degrees or even at least about 45 degrees. According to still other embodiments, the outer surface 124 of the first outer layer 120 may have an water contact angle of not greater than about 150 degrees, such as, not greater than about 145 degrees or not greater than about 140 degrees or not greater than about 135 degrees or not greater than about 130 degrees or not greater than about 125 degrees or not greater than about 120 degrees or not greater than about 115 degrees or not greater than about 110 degrees or even not greater than about 105 degrees. It will be appreciated that the outer surface 124 of the first outer layer 120 may have a water contact angle within a range between any of the minimum and maximum values noted above. It will be further appreciated that the outer surface 124 of the first outer layer 120 may have a water contact angle of any value between any of the minimum and maximum values noted above.

According to still other embodiments, the core layer 110 may include a particular material. For example, the core layer 110 may include any material selected from the group consist of a polyimide (PI), polyethylenimine (PEI), polyphenylene sulfide (PPS), polysulfone (PSU), polyethersulfone (PES), polyetherketone (PEEK), polyphenylsulfone (PPSU), polyamide-imide (PAI), polybenzimidazole (PBI), polytetrafluoroethylene (PTFE), polyamide (PA), polycarbonate (PC), polyethylene terephthalate (PET), polyurethane (PUR), and any combination thereof.

According to certain embodiments, the core layer 110 may include a polyimide (PI). According to still other embodiments, the core layer 110 may consist of a polyimide (PI). According to yet other embodiments, the core layer 110 may be a polyimide (PI) layer.

According to certain embodiments, the core layer 110 may include a polyethylenimine (PEI). According to still other embodiments, the core layer 110 may consist of a polyethylenimine (PEI). According to yet other embodiments, the core layer 110 may be a polyethylenimine (PEI) layer.

According to certain embodiments, the core layer 110 may include a polyphenylene sulfide (PPS). According to still other embodiments, the core layer 110 may consist of a polyphenylene sulfide (PPS). According to yet other embodiments, the core layer 110 may be a polyphenylene sulfide (PPS) layer.

According to certain embodiments, the core layer 110 may include a polysulfone (PSU). According to still other embodiments, the core layer 110 may consist of a polysulfone (PSU). According to yet other embodiments, the core layer 110 may be a polysulfone (PSU) layer.

According to certain embodiments, the core layer 110 may include a polyethersulfone (PES). According to still other embodiments, the core layer 110 may consist of a polyethersulfone (PES). According to yet other embodiments, the core layer 110 may be a polyethersulfone (PES) layer.

According to certain embodiments, the core layer 110 may include a polyetherketone (PEEK). According to still other embodiments, the core layer 110 may consist of a polyetherketone (PEEK). According to yet other embodiments, the core layer 110 may be a polyetherketone (PEEK) layer.

According to certain embodiments, the core layer 110 may include a polyphenylsulfone (PPSU). According to still other embodiments, the core layer 110 may consist of a polyphenylsulfone (PPSU). According to yet other embodiments, the core layer 110 may be a polyphenylsulfone (PPSU) layer.

According to certain embodiments, the core layer 110 may include a polyamide-imide (PAI). According to still other embodiments, the core layer 110 may consist of a polyamide-imide (PAI). According to yet other embodiments, the core layer 110 may be a polyamide-imide (PAI) layer.

According to certain embodiments, the core layer 110 may include a polybenzimidazole (PBI). According to still other embodiments, the core layer 110 may consist of a polybenzimidazole (PBI). According to yet other embodiments, the core layer 110 may be a polybenzimidazole (PBI) layer.

According to certain embodiments, the core layer 110 may include a polytetrafluoroethylene (PTFE). According to still other embodiments, the core layer 110 may consist of a polytetrafluoroethylene (PTFE). According to yet other embodiments, the core layer 110 may be a polytetrafluoroethylene (PTFE) layer.

According to certain embodiments, the core layer 110 may include a polyamide (PA). According to still other embodiments, the core layer 110 may consist of a polyamide (PA). According to yet other embodiments, the core layer 110 may be a polyamide (PA) layer.

According to certain embodiments, the core layer 110 may include a polycarbonate (PC). According to still other embodiments, the core layer 110 may consist of a polycarbonate (PC). According to yet other embodiments, the core layer 110 may be a polycarbonate (PC) layer.

According to certain embodiments, the core layer 110 may include a polyethylene terephthalate (PET). According to still other embodiments, the core layer 110 may consist of a polyethylene terephthalate (PET). According to yet other embodiments, the core layer 110 may be a polyethylene terephthalate (PET) layer.

According to certain embodiments, the core layer 110 may include a polyurethane (PUR). According to still other embodiments, the core layer 110 may consist of a polyurethane (PUR). According to yet other embodiments, the core layer 110 may be a polyurethane (PUR) layer.

According to certain embodiments, the core layer 110 may include any combination of a polyimide (PI), polyethylenimine (PEI), polyphenylene sulfide (PPS), polysulfone (PSU), polyethersulfone (PES), polyetherketone (PEEK), polyphenylsulfone (PPSU), polyamide-imide (PAI), polybenzimidazole (PBI), polytetrafluoroethylene (PTFE), polyamide (PA), polycarbonate (PC), polyethylene terephthalate (PET), and polyurethane (PUR).

According to still other embodiments, the core layer 110 may have a particular content of the core material, where the core material is any material noted herein. For example, the core layer 110 may have a core material content of at least about 50.0 wt. % for a total weight of the core layer 110, such as, at least about 55 wt. % or at least about 60 wt. % or at least about 65 wt. % or at least about 70 wt. % or even at least about 75 wt. %. According to still other embodiments, the core layer 110 may have a core material content of not greater than about 100 wt. % for a total weight of the core layer 110, such as, not greater than about 98 wt. % or not greater than about 96 wt. % or not greater than about 94 wt. % or not greater than about 92 wt. % or not greater than about 90 wt. % or even not greater than about 88 wt. %. It will be appreciated that the core layer 110 may have a core material content within a range between any of the minimum and maximum values noted above. It will be further appreciated that the core layer 110 may have a core material content of any value between any of the minimum and maximum values noted above.

According to still other embodiments, the core layer 110 may have a particular content of polyimide material. For example, the core layer 110 may have a polyimide material content of at least about 50.0 wt. % for a total weight of the core layer 110, such as, at least about 55 wt. % or at least about 60 wt. % or at least about 65 wt. % or at least about 70 wt. % or even at least about 75 wt. %. According to still other embodiments, the core layer 110 may have a polyimide material content of not greater than about 100 wt. % for a total weight of the core layer 110, such as, not greater than about 98 wt. % or not greater than about 96 wt. % or not greater than about 94 wt. % or not greater than about 92 wt. % or not greater than about 90 wt. % or even not greater than about 88 wt. %. It will be appreciated that the core layer 110 may have a polyimide material content within a range between any of the minimum and maximum values noted above. It will be further appreciated that the core layer 110 may have a polyimide material content of any value between any of the minimum and maximum values noted above.

According to certain embodiments, the first outer layer 120 may include a fluoropolymer material. According to still other embodiments, the first outer layer 120 may consist of a fluoropolymer material. According to yet other embodiments, the first outer layer 120 may be a fluoropolymer material.

According to still other embodiments, the first outer layer 120 may include a particular material. For example, the first outer layer 120 may include any material selected from the group consisting of polytetrafluoroethylene (PTFE), fluorinated ethylene propylene (FEP), perfluoroalkoxy alkane (PFA), polyvinyl fluoride (PVF), polyvinylidene fluoride (PVDF), ethylene tetrafluoroethylene (ETFE), ethylene chlorotrifluoroethylene (ECTFE), polychlorotrifluoroethylene (PCTFE), polychlorotrifluoroethylene (PFPE), tetrafluoroethylene (TFE), hexafluoropropylene (HFP), modified PTFE, copolymers thereof, and any combination thereof.

According to certain embodiments, the first outer layer 120 may include a polytetrafluoroethylene (PTFE). According to still other embodiments, the first outer layer 120 may consist of a polytetrafluoroethylene (PTFE). According to yet other embodiments, the first outer layer 120 may be a polytetrafluoroethylene (PTFE).

According to certain embodiments, the first outer layer 120 may include a fluorinated ethylene propylene (FEP). According to still other embodiments, the first outer layer 120 may consist of a fluorinated ethylene propylene (FEP). According to yet other embodiments, the first outer layer 120 may be a fluorinated ethylene propylene (FEP).

According to certain embodiments, the first outer layer 120 may include a perfluoroalkoxy alkane (PFA). According to still other embodiments, the first outer layer 120 may consist of a perfluoroalkoxy alkane (PFA). According to yet other embodiments, the first outer layer 120 may be a perfluoroalkoxy alkane (PFA).

According to certain embodiments, the first outer layer 120 may include a polyvinyl fluoride (PVF). According to still other embodiments, the first outer layer 120 may consist of a polyvinyl fluoride (PVF). According to yet other embodiments, the first outer layer 120 may be a polyvinyl fluoride (PVF).

According to certain embodiments, the first outer layer 120 may include a polyvinylidene fluoride (PVDF). According to still other embodiments, the first outer layer 120 may consist of a polyvinylidene fluoride (PVDF). According to yet other embodiments, the first outer layer 120 may be a polyvinylidene fluoride (PVDF).

According to certain embodiments, the first outer layer 120 may include an ethylene tetrafluoroethylene (ETFE). According to still other embodiments, the first outer layer 120 may consist of an ethylene tetrafluoroethylene (ETFE). According to yet other embodiments, the first outer layer 120 may be an ethylene tetrafluoroethylene (ETFE).

According to certain embodiments, the first outer layer 120 may include an ethylene chlorotrifluoroethylene (ECTFE). According to still other embodiments, the first outer layer 120 may consist of an ethylene chlorotrifluoroethylene (ECTFE). According to yet other embodiments, the first outer layer 120 may be an ethylene chlorotrifluoroethylene (ECTFE).

According to certain embodiments, the first outer layer 120 may include a polychlorotrifluoroethylene (PCTFE). According to still other embodiments, the first outer layer 120 may consist of a polychlorotrifluoroethylene (PCTFE). According to yet other embodiments, the first outer layer 120 may be a polychlorotrifluoroethylene (PCTFE).

According to certain embodiments, the first outer layer 120 may include a polychlorotrifluoroethylene (PFPE). According to still other embodiments, the first outer layer 120 may consist of a polychlorotrifluoroethylene (PFPE). According to yet other embodiments, the first outer layer 120 may be a polychlorotrifluoroethylene (PFPE).

According to certain embodiments, the first outer layer 120 may include a tetrafluoroethylene (TFE). According to still other embodiments, the first outer layer 120 may consist of a tetrafluoroethylene (TFE). According to yet other embodiments, the first outer layer 120 may be a tetrafluoroethylene (TFE).

According to certain embodiments, the first outer layer 120 may include a hexafluoropropylene (HFP). According to still other embodiments, the first outer layer 120 may consist of a hexafluoropropylene (HFP). According to yet other embodiments, the first outer layer 120 may be a hexafluoropropylene (HFP).

According to certain embodiments, the first outer layer 120 may include a modified PTFE. According to still other embodiments, the first outer layer 120 may consist of a modified PTFE. According to yet other embodiments, the first outer layer 120 may be a modified PTFE.

According to certain embodiments, the first outer layer 120 may include any copolymer of polytetrafluoroethylene (PTFE), fluorinated ethylene propylene (FEP), perfluoroalkoxy alkane (PFA), polyvinyl fluoride (PVF), polyvinylidene fluoride (PVDF), ethylene tetrafluoroethylene (ETFE), ethylene chlorotrifluoroethylene (ECTFE), polychlorotrifluoroethylene (PCTFE), polychlorotrifluoroethylene (PFPE), tetrafluoroethylene (TFE), hexafluoropropylene (HFP), and modified PTFE.

According to certain embodiments, the first outer layer 120 may include any combination of polytetrafluoroethylene (PTFE), fluorinated ethylene propylene (FEP), perfluoroalkoxy alkane (PFA), polyvinyl fluoride (PVF), polyvinylidene fluoride (PVDF), ethylene tetrafluoroethylene (ETFE), ethylene chlorotrifluoroethylene (ECTFE), polychlorotrifluoroethylene (PCTFE), polychlorotrifluoroethylene (PFPE), tetrafluoroethylene (TFE), hexafluoropropylene (HFP), and modified PTFE.

According to still other embodiments, the first outer layer 120 may have a particular content of fluoropolymer material. For example, the first outer layer 120 may have a fluoropolymer material content of at least about 50.0 wt. % for a total weight of the first outer layer 120, such as, at least about 55 wt. % or at least about 60 wt. % or at least about 65 wt. % or at least about 70 wt. % or even at least about 75 wt. %. According to still other embodiments, the first outer layer 120 may have a fluoropolymer material content of not greater than about 100 wt. % for a total weight of the first outer layer 120, such as, not greater than about 98 wt. % or not greater than about 96 wt. % or not greater than about 94 wt. % or not greater than about 92 wt. % or not greater than about 90 wt. % or even not greater than about 88 wt. %. It will be appreciated that the first outer layer 120 may have a fluoropolymer material content within a range between any of the minimum and maximum values noted above. It will be further appreciated that the first outer layer 120 may have a fluoropolymer material content of any value between any of the minimum and maximum values noted above.

According to yet other embodiments, the core layer 110 may have a particular thickness. For example, the core layer 110 may have a thickness of at least about 10 microns, such as, at least about 50 microns or at least about 100 microns or at least about 150 microns or at least about 200 microns or at least about 250 microns or at least about 300 microns or at least about 350 microns or at least about 400 microns or at least about 450 microns or at least about 500 microns or at least about 550 microns or at least about 600 microns or at least about 650 microns or even at least about 700 microns. According to still other embodiments, the core layer 110 may have a thickness of not greater than about 3000 microns, such as, not greater than about 2750 microns or not greater than about 2500 microns or not greater than about 2250 microns or not greater than about 2000 microns or not greater than about 1750 microns or not greater than about 1500 microns or not greater than about 1250 microns or even not greater than about 1000 microns. It will be appreciated that the thickness of the core layer 110 may be within a range between any of the minimum and maximum values noted above. It will be further appreciated that the core layer 110 may be any value between any of the minimum and maximum values noted above.

According to yet other embodiments, the first outer layer 120 may have a particular thickness. For example, the first outer layer 120 may have a thickness of at least about 0.1 microns, such as, at least about 0.5 microns or at least about 1.0 microns or at least about 5 microns or at least about 10 microns or at least about 15 microns or at least about 20 microns or at least about 25 microns or at least about 30 microns or at least about 35 microns or at least about 40 microns or at least about 45 microns or even at least about 50 microns. According to still other embodiments, the first outer layer 120 may have a thickness of not greater than about 200 microns, such as, not greater than about 190 microns or not greater than about 180 microns or not greater than about 170 microns or not greater than about 160 microns or not greater than about 150 microns or not greater than about 140 microns or not greater than about 130 microns or even not greater than about 120 microns. It will be appreciated that the thickness of the first outer layer 120 may be within a range between any of the minimum and maximum values noted above. It will be further appreciated that the first outer layer 120 may be any value between any of the minimum and maximum values noted above.

According to yet other embodiments, the multilayer gasket 100 may have a particular thickness. For example, the multilayer gasket 100 may have a thickness of at least about 10 microns, such as, at least about 50 microns or at least about 100 microns or at least about 150 microns or at least about 200 microns or at least about 250 microns or at least about 300 microns or at least about 350 microns or at least about 400 microns or at least about 450 microns or at least about 500 microns or at least about 550 microns or at least about 600 microns or at least about 650 microns or even at least about 700 microns. According to still other embodiments, the multilayer gasket 100 may have a thickness of not greater than about 3400 microns, such as, not greater than about 3250 microns or not greater than about 3000 microns or not greater than about 2750 microns or not greater than about 2500 microns or not greater than about 2250 microns or not greater than about 2000 microns or not greater than about 1750 microns or not greater than about 1500 microns or not greater than about 1250 microns or even not greater than about 1000 microns. It will be appreciated that the thickness of the multilayer gasket 100 may be within a range between any of the minimum and maximum values noted above. It will be further appreciated that the multilayer gasket 100 may be any value between any of the minimum and maximum values noted above.

According to still other embodiments, the multilayer gasket 100 may have a particular elastic modulus as measured according to ASTM D882 (for gaskets ≤1 mm in total thickness) or ASTM D638 (for gaskets >1 mm in total thickness). For example, the multilayer gasket 100 may have an elastic modulus of at least about 0.1 GPa, such as, at least about 0.5 GPa or at least about 1.0 GPa or at least about 1.5 GPa or at least about 2.0 GPa or at least about 2.5 GPa or at least about 3.0 GPa or at least about 3.5 GPa or at least about 4.0 GPa or even at least about 4.5 GPa. According to still other embodiments, the multilayer gasket 100 may have an elastic modulus of not greater than about 10 GPa, such as, not greater than about 9.5 GPa or not greater than about 9.0 GPa or not greater than about 8.5 GPa or not greater than about 8.0 GPa or not greater than about 7.5 GPa or not greater than about 7.0 GPa or not greater than about 6.5 GPa or not greater than about 6.0 GPa or even not greater than about 5.5 GPa. It will be appreciated that the multilayer gasket 100 may have an elastic modulus within a range between any of the minimum and maximum values noted above. It will be further appreciated that the multilayer gasket 100 may have an elastic modulus of any value between any of the minimum and maximum values noted above.

According to certain embodiments, a multilayer gasket 100 may have a first outer layer 120 on either side of the core layer 110 (not shown in FIG. 1). According to still other alternative embodiments, a multilayer gasket 100 may have two first outer layers 120, with the core layer 110 between the two first outer layers 120 (not shown in FIG. 1).

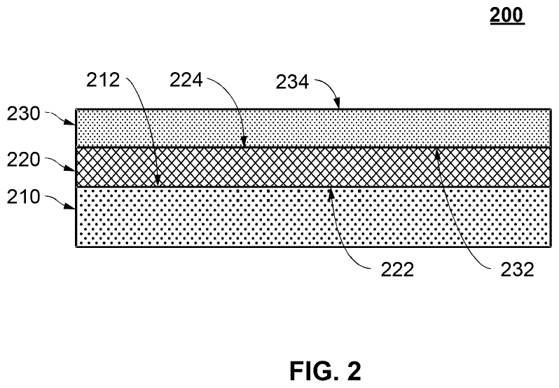

For purposes of illustration, FIG. 2 includes an illustration of multilayer gasket 200 according to embodiments described herein. As shown in FIG. 2, a multilayer gasket 200 may include a core layer 210, a first outer layer 220 overlying a first surface 212 of the core layer 210, and a second outer layer 230 overlying an outer surface 224 of the first outer layer 220. As further shown in FIG. 2, the first outer layer 220 may have an inner surface 222 adjacent to the first surface 212 of the core layer 210, and the first outer layer 220 may have the outer surface 224 opposite to the first surface 212 of the core layer 210. As also shown in FIG. 2, the second outer layer 230 may have an inner surface 232 adjacent to the outer surface 224 of the first outer layer 220, and the second outer layer 230 may have the outer surface 234 opposite to the outer surface 224 of the first outer layer 220.

It will be appreciated that all descriptions provided herein in reference to the multilayer gasket 100 and its components may further apply to corresponding aspects of the multilayer gasket 200 and its corresponding components.

According to particular embodiments, the second outer layer 230 may include a low-melt fluoropolymer material.

According to still other embodiments, the low-melt fluoropolymer material may have a particular melting temperature as measured using differential scanning calorimetry (DSC) according to ASTM D4591. For example, the low-melt fluoropolymer material may have a melting temperature of at least about 50° C., such as, at least about 55° C. or at least about 60° C. or at least about 65° C. or at least about 70° C. or at least about 75° C. or at least about 80° C. or at least about 85° C. or at least about 90° C. or at least about 95° C. or even at least about 100° C. According to still other embodiments, the low-melt fluoropolymer material may have a melting temperature of not greater than about 300° C., such as, not greater than about 290° C. or not greater than about 280° C. or not greater than about 270° C. or not greater than about 260° C. or not greater than about 250° C. not greater than about 240° C. or not greater than about 230° C. or not greater than about 220° C. or not greater than about 210° C. or not greater than about 200° C. or not greater than about 175° C. or not greater than about 150° C. or even not greater than about 125° C. It will be appreciated that the melting temperature of the low-melt fluoropolymer material may be within a range between any of the minimum and maximum values noted above. It will be further appreciated that the melting temperature of the low-melt fluoropolymer material may be any value between any of the minimum and maximum values noted above.

According to yet other embodiments, the low-melt fluoropolymer material may include a particular material. For example, the low-melt fluoropolymer material may include polyvinylidene fluoride (PVDF). According to still other embodiments, the low-melt fluoropolymer material may include a terpolymer of tetrafluoroethylene, hexafluoropropylene and vinylidene fluoride (THV). According to still other embodiments, the low-melt fluoropolymer material may include ethylene tetrafluoroethylene (ETFE). According to still other embodiments, the low-melt fluoropolymer material may include ethylene chlorotrifluoroethylene (ECTFE). According to still other embodiments, the low-melt fluoropolymer material may include a PVDF-HFP co-polymer. According to still other embodiments, the low-melt fluoropolymer material may include a mixture of PVDF and PTFE (PVDF/PTFE mixture). According to still other embodiments, the low-melt fluoropolymer material may include any combination of PVDF, THV, ETFE, ECTFE, PVDF-HFP co-polymer or PVDF/PTFE mixture.

According to yet other embodiments, the low-melt fluoropolymer material may consist of a particular material. For example, the low-melt fluoropolymer material may consist of polyvinylidene fluoride (PVDF). According to still other embodiments, the low-melt fluoropolymer material may consist of a terpolymer of tetrafluoroethylene, hexafluoropropylene and vinylidene fluoride (THV). According to still other embodiments, the low-melt fluoropolymer material may consist of ethylene tetrafluoroethylene (ETFE). According to still other embodiments, the low-melt fluoropolymer material may consist of ethylene chlorotrifluoroethylene (ECTFE). According to still other embodiments, the low-melt fluoropolymer material may consist of a PVDF-HFP co-polymer. According to still other embodiments, the low-melt fluoropolymer material may consist of a mixture of PVDF and PTFE (PVDF/PTFE mixture). According to still other embodiments, the low-melt fluoropolymer material may consist of any combination of PVDF, THV, ETFE, ECTFE, PVDF-HFP co-polymer or PVDF/PTFE mixture.

According to yet other embodiments, the low-melt fluoropolymer material may be a layer of a particular material. For example, the low-melt fluoropolymer material may be a polyvinylidene fluoride (PVDF) layer. According to still other embodiments, the low-melt fluoropolymer material may be a terpolymer of tetrafluoroethylene, hexafluoropropylene and vinylidene fluoride (THV) layer. According to still other embodiments, the low-melt fluoropolymer material may be an ethylene tetrafluoroethylene (ETFE) layer. According to still other embodiments, the low-melt fluoropolymer material may be an ethylene chlorotrifluoroethylene (ECTFE) layer. According to still other embodiments, the low-melt fluoropolymer material may be a PVDF-HFP co-polymer layer. According to still other embodiments, the low-melt fluoropolymer material may be a layer of a mixture of PVDF and PTFE (PVDF/PTFE mixture). According to still other embodiments, the low-melt fluoropolymer material may be a layer of any combination of PVDF, THV, ETFE, ECTFE, PVDF-HFP co-polymer or PVDF/PTFE mixture.

According to still other embodiments, the low-melt fluoropolymer material may include a particular content of fluoropolymer. For example, the low-melt fluoropolymer material may have a fluoropolymer content of at least about 50 wt. % for a total weight of the low-melt fluoropolymer material, such as, at least about 55 wt. % or at least about 60 wt. % or at least about 65 wt. % or at least about 70 wt. % or even at least about 75 wt. %. According to still other embodiments, the low-melt fluoropolymer material may have a fluoropolymer content of not greater than about 100 wt. % for a total weight of the low-melt fluoropolymer material, such as, not greater than about 99 wt. % or not greater than about 98 wt. % or not greater than about 97 wt. % or not greater than about 96 wt. % or not greater than about 95 wt. % or not greater than about 90 wt. % or not greater than about 85 wt. % or not greater than about 80 wt. % or even not greater than about 77 wt. %. It will be appreciated that the fluoropolymer content of the low-melt fluoropolymer material may be within a range between any of the minimum and maximum values noted above. It will be further appreciated that the fluoropolymer content of the low-melt fluoropolymer material may be any value between any of the minimum and maximum values noted above.

According to still other embodiments, the low-melt fluoropolymer material may include a particular content of PVDF. For example, the low-melt fluoropolymer material may have a PVDF content of at least about 50 wt. % for a total weight of the low-melt fluoropolymer material, such as, at least about 55 wt. % or at least about 60 wt. % or at least about 65 wt. % or at least about 70 wt. % or even at least about 75 wt. %. According to still other embodiments, the low-melt fluoropolymer material may have a PVDF content of not greater than about 100 wt. % for a total weight of the low-melt fluoropolymer material, such as, not greater than about 99 wt. % or not greater than about 98 wt. % or not greater than about 97 wt. % or not greater than about 96 wt. % or not greater than about 95 wt. % or not greater than about 90 wt. % or not greater than about 85 wt. % or not greater than about 80 wt. % or even not greater than about 77 wt. %. It will be appreciated that the PVDF content of the low-melt fluoropolymer material may be within a range between any of the minimum and maximum values noted above. It will be further appreciated that the PVDF content of the low-melt fluoropolymer material may be any value between any of the minimum and maximum values noted above.

According to still other embodiments, the low-melt fluoropolymer material may include a particular content of PVDF-HFP copolymer. For example, the low-melt fluoropolymer material may have a PVDF-HFP copolymer content of at least about 50 wt. % for a total weight of the low-melt fluoropolymer material, such as, at least about 55 wt. % or at least about 60 wt. % or at least about 65 wt. % or at least about 70 wt. % or even at least about 75 wt. %. According to still other embodiments, the low-melt fluoropolymer material may have a PVDF-HFP copolymer content of not greater than about 100 wt. % for a total weight of the low-melt fluoropolymer material, such as, not greater than about 99 wt. % or not greater than about 98 wt. % or not greater than about 97 wt. % or not greater than about 96 wt. % or not greater than about 95 wt. % or not greater than about 90 wt. % or not greater than about 85 wt. % or not greater than about 80 wt. % or even not greater than about 77 wt. %. It will be appreciated that the PVDF-HFP copolymer content of the low-melt fluoropolymer material may be within a range between any of the minimum and maximum values noted above. It will be further appreciated that the PVDF-HFP copolymer content of the low-melt fluoropolymer material may be any value between any of the minimum and maximum values noted above.

According to still other embodiments, the second outer layer 230 may include a particular content of fluoropolymer. For example, the second outer layer 230 may have a fluoropolymer content of at least about 50 wt. % for a total weight of the second outer layer 230, such as, at least about 55 wt. % or at least about 60 wt. % or at least about 65 wt. % or at least about 70 wt. % or even at least about 75 wt. %. According to still other embodiments, the second outer layer 230 may have a fluoropolymer content of not greater than about 100 wt. % for a total weight of the second outer layer 230, such as, not greater than about 99 wt. % or not greater than about 98 wt. % or not greater than about 97 wt. % or not greater than about 96 wt. % or not greater than about 95 wt. % or not greater than about 90 wt. % or not greater than about 85 wt. % or not greater than about 80 wt. % or even not greater than about 77 wt. %. It will be appreciated that the fluoropolymer content of the second outer layer 230 may be within a range between any of the minimum and maximum values noted above. It will be further appreciated that the fluoropolymer content of the second outer layer 230 may be any value between any of the minimum and maximum values noted above.

According to still other embodiments, the second outer layer 230 may include a particular content of PVDF. For example, the second outer layer 230 may have a PVDF content of at least about 50 wt. % for a total weight of the second outer layer 230, such as, at least about 55 wt. % or at least about 60 wt. % or at least about 65 wt. % or at least about 70 wt. % or even at least about 75 wt. %. According to still other embodiments, the second outer layer 230 may have a PVDF content of not greater than about 100 wt. % for a total weight of the second outer layer 230, such as, not greater than about 99 wt. % or not greater than about 98 wt. % or not greater than about 97 wt. % or not greater than about 96 wt. % or not greater than about 95 wt. % or not greater than about 90 wt. % or not greater than about 85 wt. % or not greater than about 80 wt. % or even not greater than about 77 wt. %. It will be appreciated that the PVDF content of the second outer layer 230 may be within a range between any of the minimum and maximum values noted above. It will be further appreciated that the PVDF content of the second outer layer 230 may be any value between any of the minimum and maximum values noted above.

According to still other embodiments, the second outer layer 230 may include a particular content of PVDF-HFP copolymer. For example, the second outer layer 230 may have a PVDF-HFP copolymer content of at least about 50 wt. % for a total weight of the second outer layer 230, such as, at least about 55 wt. % or at least about 60 wt. % or at least about 65 wt. % or at least about 70 wt. % or even at least about 75 wt. %. According to still other embodiments, the second outer layer 230 may have a PVDF-HFP copolymer content of not greater than about 100 wt. % for a total weight of the second outer layer 230, such as, not greater than about 99 wt. % or not greater than about 98 wt. % or not greater than about 97 wt. % or not greater than about 96 wt. % or not greater than about 95 wt. % or not greater than about 90 wt. % or not greater than about 85 wt. % or not greater than about 80 wt. % or even not greater than about 77 wt. %. It will be appreciated that the PVDF-HFP copolymer content of the second outer layer 230 may be within a range between any of the minimum and maximum values noted above. It will be further appreciated that the PVDF-HFP copolymer content of the second outer layer 230 may be any value between any of the minimum and maximum values noted above.

According to still other embodiments, the PVDF-HFP co-polymer may include a particular content of HFP. For example, PVDF-HFP co-polymer may have an HFP content of at least about 0.5 wt. % for a total weight of the PVDF-HFP co-polymer, such as, at least about 1 wt. % or at least about 5 wt. % or at least about 10 wt. % or at least about 15 wt. % or at least about 20 wt. % or even at least about 25 wt. %. According to still other embodiments, the PVDF-HFP co-polymer may have an HFP content of not greater than about 50 wt. % for a total weight of the PVDF-HFP co-polymer, such as, not greater than about 45 wt. % or not greater than about 40 wt. % or not greater than about 35 wt. % or even not greater than about 30 wt. %. It will be appreciated that the HFP content of the PVDF-HFP co-polymer may be within a range between any of the minimum and maximum values noted above. It will be further appreciated that the HFP content of the PVDF-HFP co-polymer may be any value between any of the minimum and maximum values noted above.

According to still other embodiments, the PVDF-HFP co-polymer may include a particular content of PVDF. For example, PVDF-HFP co-polymer may have a PVDF content of at least about 50 wt. % for a total weight of the PVDF-HFP co-polymer, such as, at least about 55 wt. % or at least about 60 wt. % or at least about 65 wt. % or at least about 70 wt. % or even at least about 75 wt. %. According to still other embodiments, the PVDF-HFP co-polymer may have a PVDF content of not greater than about 100 wt. % for a total weight of the PVDF-HFP co-polymer, such as, not greater than about 95 wt. % or not greater than about 90 wt. % or not greater than about 85 wt. % or even not greater than about 80 wt. %. It will be appreciated that the PVDF content of the PVDF-HFP co-polymer may be within a range between any of the minimum and maximum values noted above. It will be further appreciated that the PVDF content of the PVDF-HFP co-polymer may be any value between any of the minimum and maximum values noted above.

According to still other embodiments, the outer surface 234 of the second outer layer 230 may have a particular surface roughness when measured using a long wavelength cutoff of 800 (as defined in ASME B46.1) as measured according to ASTM D4417. For example, the outer surface 234 of the first outer layer 230 may have a surface roughness of at least about 0.01 microns, such as, at least about 0.05 microns or at least about 0.1 microns or at least about 0.5 microns or at least about 0.7 microns or at least about 1.0 microns or at least about 1.2 microns or at least about 1.5 microns or at least about 1.7 microns or at least about 2.0 microns or even at least about 2.2 microns. According to still other embodiments, the outer surface 234 of the first outer layer 230 may have a surface roughness of not greater than about 5.0 microns, such as, not greater than about 4.7 microns or not greater than about 4.5 microns or not greater than about 4.2 microns or not greater than about 4.0 microns or not greater than about 3.7 microns or not greater than about 3.5 microns or not greater than about 3.2 microns or not greater than about 3.0 microns or even not greater than about 2.7 microns. It will be appreciated that the outer surface 234 of the first outer layer 230 may have a surface roughness within a range between any of the minimum and maximum values noted above. It will be further appreciated that the outer surface 234 of the first outer layer 230 may have a surface roughness of any value between any of the minimum and maximum values noted above.

According to particular embodiments, the inner surface 232 of the second outer layer 230 may be a corona treated surface. According to other embodiments, the inner surface 232 of the second outer layer 230 may be a plasma treated surface. According to yet other embodiments, the inner surface 232 of the second outer layer 230 may be any combination of a corona treated surface and a plasma treated surface.

According to other embodiments, the outer surface 234 of the second outer layer 230 may be a corona treated surface. According to other embodiments, the outer surface 234 of the second outer layer 230 may be a plasma treated surface. According to yet other embodiments, the outer surface 234 of the second outer layer 230 may be any combination of a corona treated surface and a plasma treated surface.

According to still other embodiments, the inner surface 232 and the outer surface 234 of the second outer layer 230 may both be a corona treated surface. According to other embodiments, the inner surface 232 and the outer surface 234 of the second outer layer 230 may both be a plasma treated surface. According to yet other embodiments, the inner surface 232 and the outer surface 234 of the second outer layer 230 may both be any combination of a corona treated surface and a plasma treated surface.

According to still other embodiments, the outer surface 234 of the second outer layer 230 may have a particular adhesion strength as measured according to ASTM D1876. For example, the outer surface 234 of the second outer layer 230 may have an adhesion strength of at least about 0.1 lb./in, such as, at least about 0.5 lb./in or at least about 1.0 lb./in or at least about 1.5 lb./in or at least about 2.0 lb./in or at least about 2.5 lb./in or at least about 3.0 lb./in or at least about 3.5 lb./in or at least about 4.0 lb./in or even at least about 4.5 lb./in. According to still other embodiments, the outer surface 234 of the second outer layer 230 may have an adhesion strength of not greater than about 10 lb./in, such as, not greater than about 9.5 lb./in or not greater than about 9.0 lb./in or not greater than about 8.5 lb./in or not greater than about 8.0 lb./in or not greater than about 7.5 lb./in or not greater than about 7.0 lb./in or not greater than about 6.5 lb./in or not greater than about 6.0 lb./in or even not greater than about 5.5 lb./in. It will be appreciated that the outer surface 234 of the second outer layer 230 may have an adhesion strength within a range between any of the minimum and maximum values noted above. It will be further appreciated that the outer surface 234 of the second outer layer 230 may have an adhesion strength of any value between any of the minimum and maximum values noted above.

According to still other embodiments, the outer surface 234 of the second outer layer 230 may have a particular surface energy as measured according to ASTM D7490. For example, the outer surface 234 of the second outer layer 230 may have a surface energy of at least about 1.0 mJ/m², such as, at least about 5 mJ/m² or at least about 10 mJ/m² or at least about 15 mJ/m² or at least about 20 mJ/m² or at least about 25 mJ/m² or at least about 30 mJ/m² or at least about 35 mJ/m² or at least about 40 mJ/m² or even at least about 45 mJ/m². According to still other embodiments, the outer surface 234 of the second outer layer 230 may have a surface energy of not greater than about 100 mJ/m², such as, not greater than about 95 mJ/m² or not greater than about 90 mJ/m² or not greater than about 85 mJ/m² or not greater than about 80 mJ/m² or not greater than about 75 mJ/m² or not greater than about 70 mJ/m² or not greater than about 65 mJ/m² or not greater than about 60 mJ/m² or even not greater than about 55 mJ/m². It will be appreciated that the outer surface 234 of the second outer layer 230 may have a surface energy within a range between any of the minimum and maximum values noted above. It will be further appreciated that the outer surface 234 of the second outer layer 230 may have a surface energy of any value between any of the minimum and maximum values noted above.

According to still other embodiments, the outer surface 234 of the second outer layer 230 may have a particular water contact angle as measured according to ASTM D5946. For example, the outer surface 234 of the second outer layer 230 may have a water contact angle of at least about 1.0 degrees, such as, at least about 5 degrees or at least about 10 degrees or at least about 15 degrees or at least about 20 degrees or at least about 25 degrees or at least about 30 degrees or at least about 35 degrees or at least about 40 degrees or even at least about 45 degrees. According to still other embodiments, the outer surface 234 of the second outer layer 230 may have an water contact angle of not greater than about 150 degrees, such as, not greater than about 145 degrees or not greater than about 140 degrees or not greater than about 135 degrees or not greater than about 130 degrees or not greater than about 125 degrees or not greater than about 120 degrees or not greater than about 115 degrees or not greater than about 110 degrees or even not greater than about 105 degrees. It will be appreciated that the outer surface 234 of the second outer layer 230 may have a water contact angle within a range between any of the minimum and maximum values noted above. It will be further appreciated that the outer surface 234 of the second outer layer 230 may have a water contact angle of any value between any of the minimum and maximum values noted above.

According to certain embodiments, the second outer layer 230 may include a fluoropolymer material. According to still other embodiments, the second outer layer 230 may consist of a fluoropolymer material. According to yet other embodiments, the second outer layer 230 may be a fluoropolymer material.

According to still other embodiments, the second outer layer 230 may include a particular material. For example, the second outer layer 230 may include any material selected from the group consisting of polytetrafluoroethylene (PTFE), fluorinated ethylene propylene (FEP), perfluoroalkoxy alkane (PFA), polyvinyl fluoride (PVF), polyvinylidene fluoride (PVDF), ethylene tetrafluoroethylene (ETFE), ethylene chlorotrifluoroethylene (ECTFE), polychlorotrifluoroethylene (PCTFE), polychlorotrifluoroethylene (PFPE), tetrafluoroethylene (TFE), hexafluoropropylene (HFP), modified PTFE, copolymers thereof, and any combination thereof.

According to certain embodiments, the second outer layer 230 may include a polytetrafluoroethylene (PTFE). According to still other embodiments, the second outer layer 230 may consist of a polytetrafluoroethylene (PTFE). According to yet other embodiments, the second outer layer 230 may be a polytetrafluoroethylene (PTFE).

According to certain embodiments, the second outer layer 230 may include a fluorinated ethylene propylene (FEP). According to still other embodiments, the second outer layer 230 may consist of a fluorinated ethylene propylene (FEP). According to yet other embodiments, the second outer layer 230 may be a fluorinated ethylene propylene (FEP).

According to certain embodiments, the second outer layer 230 may include a perfluoroalkoxy alkane (PFA). According to still other embodiments, the second outer layer 230 may consist of a perfluoroalkoxy alkane (PFA). According to yet other embodiments, the second outer layer 230 may be a perfluoroalkoxy alkane (PFA).

According to certain embodiments, the second outer layer 230 may include a polyvinyl fluoride (PVF). According to still other embodiments, the second outer layer 230 may consist of a polyvinyl fluoride (PVF). According to yet other embodiments, the second outer layer 230 may be a polyvinyl fluoride (PVF).

According to certain embodiments, the second outer layer 230 may include a polyvinylidene fluoride (PVDF). According to still other embodiments, the second outer layer 230 may consist of a polyvinylidene fluoride (PVDF). According to yet other embodiments, the second outer layer 230 may be a polyvinylidene fluoride (PVDF).

According to certain embodiments, the second outer layer 230 may include an ethylene tetrafluoroethylene (ETFE). According to still other embodiments, the second outer layer 230 may consist of an ethylene tetrafluoroethylene (ETFE). According to yet other embodiments, the second outer layer 230 may be an ethylene tetrafluoroethylene (ETFE).

According to certain embodiments, the second outer layer 230 may include an ethylene chlorotrifluoroethylene (ECTFE). According to still other embodiments, the second outer layer 230 may consist of an ethylene chlorotrifluoroethylene (ECTFE). According to yet other embodiments, the second outer layer 230 may be an ethylene chlorotrifluoroethylene (ECTFE).

According to certain embodiments, the second outer layer 230 may include a polychlorotrifluoroethylene (PCTFE). According to still other embodiments, the second outer layer 230 may consist of a polychlorotrifluoroethylene (PCTFE). According to yet other embodiments, the second outer layer 230 may be a polychlorotrifluoroethylene (PCTFE).

According to certain embodiments, the second outer layer 230 may include a polychlorotrifluoroethylene (PFPE). According to still other embodiments, the second outer layer 230 may consist of a polychlorotrifluoroethylene (PFPE). According to yet other embodiments, the second outer layer 230 may be a polychlorotrifluoroethylene (PFPE).

According to certain embodiments, the second outer layer 230 may include a tetrafluoroethylene (TFE). According to still other embodiments, the second outer layer 230 may consist of a tetrafluoroethylene (TFE). According to yet other embodiments, the second outer layer 230 may be a tetrafluoroethylene (TFE).

According to certain embodiments, the second outer layer 230 may include a hexafluoropropylene (HFP). According to still other embodiments, the second outer layer 230 may consist of a hexafluoropropylene (HFP). According to yet other embodiments, the second outer layer 230 may be a hexafluoropropylene (HFP).

According to certain embodiments, the second outer layer 230 may include a modified PTFE. According to still other embodiments, the second outer layer 230 may consist of a modified PTFE. According to yet other embodiments, the second outer layer 230 may be a modified PTFE.

According to certain embodiments, the second outer layer 230 may include any copolymer of polytetrafluoroethylene (PTFE), fluorinated ethylene propylene (FEP), perfluoroalkoxy alkane (PFA), polyvinyl fluoride (PVF), polyvinylidene fluoride (PVDF), ethylene tetrafluoroethylene (ETFE), ethylene chlorotrifluoroethylene (ECTFE), polychlorotrifluoroethylene (PCTFE), polychlorotrifluoroethylene (PFPE), tetrafluoroethylene (TFE), hexafluoropropylene (HFP), and modified PTFE.

According to certain embodiments, the second outer layer 230 may include any combination of polytetrafluoroethylene (PTFE), fluorinated ethylene propylene (FEP), perfluoroalkoxy alkane (PFA), polyvinyl fluoride (PVF), polyvinylidene fluoride (PVDF), ethylene tetrafluoroethylene (ETFE), ethylene chlorotrifluoroethylene (ECTFE), polychlorotrifluoroethylene (PCTFE), polychlorotrifluoroethylene (PFPE), tetrafluoroethylene (TFE), hexafluoropropylene (HFP), and modified PTFE.

According to still other embodiments, the second outer layer 230 may have a particular content of fluoropolymer material. For example, the second outer layer 230 may have a fluoropolymer material content of at least about 50.0 wt. % for a total weight of the second outer layer 230, such as, at least about 55 wt. % or at least about 60 wt. % or at least about 65 wt. % or at least about 70 wt. % or even at least about 75 wt. %. According to still other embodiments, the second outer layer 230 may have a fluoropolymer material content of not greater than about 100 wt. % for a total weight of the second outer layer 230, such as, not greater than about 98 wt. % or not greater than about 96 wt. % or not greater than about 94 wt. % or not greater than about 92 wt. % or not greater than about 90 wt. % or even not greater than about 88 wt. %. It will be appreciated that the second outer layer 230 may have a fluoropolymer material content within a range between any of the minimum and maximum values noted above. It will be further appreciated that the second outer layer 230 may have a fluoropolymer material content of any value between any of the minimum and maximum values noted above.

According to yet other embodiments, the second outer layer 230 may have a particular thickness. For example, the second outer layer 230 may have a thickness of at least about 0.1 microns, such as, at least about 0.5 microns or at least about 1.0 microns or at least about 5 microns or at least about 10 microns or at least about 15 microns or at least about 20 microns or at least about 25 microns or at least about 30 microns or at least about 35 microns or at least about 40 microns or at least about 45 microns or even at least about 50 microns. According to still other embodiments, the second outer layer 230 may have a thickness of not greater than about 200 microns, such as, not greater than about 190 microns or not greater than about 180 microns or not greater than about 170 microns or not greater than about 160 microns or not greater than about 150 microns or not greater than about 140 microns or not greater than about 130 microns or even not greater than about 120 microns. It will be appreciated that the thickness of the second outer layer 230 may be within a range between any of the minimum and maximum values noted above. It will be further appreciated that the second outer layer 230 may be any value between any of the minimum and maximum values noted above.

According to certain embodiments, a multilayer gasket 200 may have a first outer layer 220 and a second outer layer 230 as described herein on either side of the core layer 210 (not shown in FIG. 2). According to still other alternative embodiments, a multilayer gasket 100 may have two sets of a first outer layer 220 and a second outer layer 230, with the core layer 110 between the two sets of the first outer layer 220 and the second outer layer 230 (Not Shown in FIG. 2).

According to still other embodiments described herein, the multilayer gasket may be incorporated into an electrolyzer membrane electrode assembly (MEA).

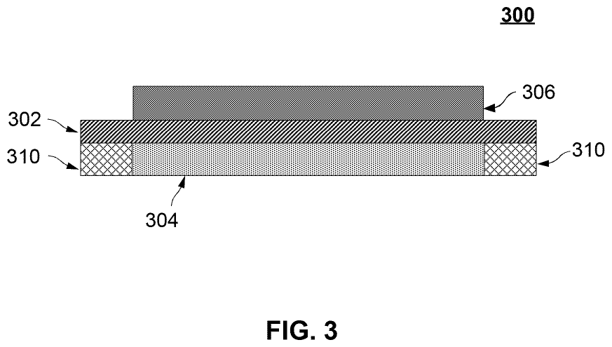

For purposes of illustration, FIG. 3 includes a cross-sectional illustration of an electrolyzer membrane electrode assembly (MEA) 300 according to embodiments described herein. As shown in FIG. 3, the electrolyzer membrane electrode assembly (MEA) 300 may include a membrane 302, an anode 304, a cathode 306, and a multilayer gasket 310 disposed in contact with the membrane 302 and surrounding an outer perimeter of the anode 304.

It will be appreciated that, though not shown in FIG. 3, the gasket 310 may encircle the entire outer perimeter of the anode 304.

It will be further appreciated that though only a single gasket 310 is shown in FIG. 3, according to alternative embodiments, another gasket 310 (not shown) may be disposed in contact with the membrane 302 and surrounding an outer perimeter of the cathode 306. According to certain embodiments, an electrolyzer membrane electrode assembly (MEA) 300 may include a gasket 310 on the cathode side of the assembly, on the anode side of the assembly, or on both the cathode side of the assembly and the anode side of the assembly.

According to certain embodiments, it will be appreciated that the multilayer gasket 310 of the electrolyzer membrane electrode assembly (MEA) 300, as shown in FIG. 3, may include any of the components and may be described as having any of the characteristics described herein with reference to the multilayer gasket 100 as shown in FIG. 1, or the multilayer gasket 200 as shown in FIG. 2.

According to certain embodiments, the membrane 302 may include a particular material. For example, the membrane 302 may include Nafion, Zirfon, Pemion, Aemion, sulfonated tetrafluoroethylene, polysulfone, sulfonated polyimide (SPI), polybenzimidazole (PBI), polystyrene, polyphosphazene, sulfonated poly (arylene ether ketone) (SPAEK), sulfonated poly (ether ether ketone) (SPEEK), sulfonated poly (arylene sulfone) (SPAS), sulfonated poly (arylene ether nitrile) (SPEN), copolymers thereof, blends thereof, and other ionically-conductive materials. According to still other embodiments, the membrane 302 may consist of Nafion, Zirfon, Pemion, Aemion, sulfonated tetrafluoroethylene, polysulfone, sulfonated polyimide (SPI), polybenzimidazole (PBI), polystyrene, polyphosphazene, sulfonated poly (arylene ether ketone) (SPAEK), sulfonated poly (ether ether ketone) (SPEEK), sulfonated poly (arylene sulfone) (SPAS), sulfonated poly (arylene ether nitrile) (SPEN), copolymers thereof, blends thereof, and other ionically-conductive materials.

According to yet other embodiments, the membrane 302 may have a particular thickness. For example, the membrane 302 may have a thickness of at least about 1.0 microns, such as, at least about 1.5 microns or at least about 3.0 microns or at least about 5 microns or at least about 10 microns or at least about 15 microns or at least about 20 microns or at least about 25 microns or at least about 50 microns or at least about 100 microns or at least about 150 microns or at least about 200 microns or even at least about 250 microns. According to still other embodiments, the membrane 302 may have a thickness of not greater than about 500 microns, such as, not greater than about 475 microns or not greater than about 450 microns or not greater than about 425 microns or not greater than about 400 microns or not greater than about 375 microns or not greater than about 350 microns or even not greater than about 325 microns. It will be appreciated that the thickness of the membrane 302 may be within a range between any of the minimum and maximum values noted above. It will be further appreciated that the membrane 302 may be any value between any of the minimum and maximum values noted above.

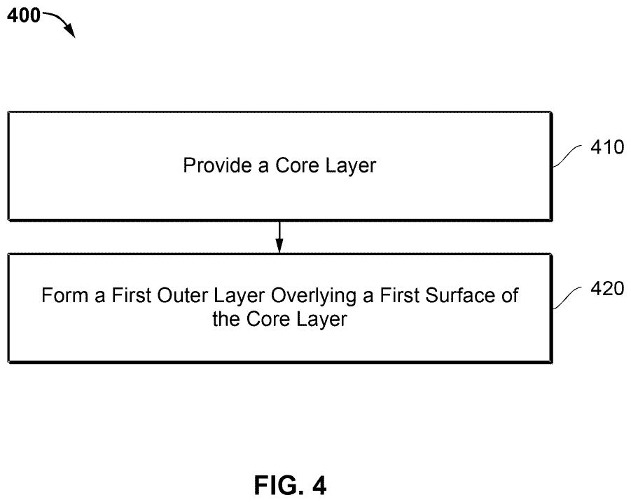

Referring now to a method of forming a multilayer gasket as described herein, FIG. 4 includes a diagram showing a forming method 400 for forming a multilayer gasket according to embodiments described herein. According to particular embodiments, the forming method 400 may include a first step 410 of providing a core layer, and a second step 420 of forming a first outer layer overlying a first surface of the core layer.

Regarding the first step 410 of providing a core layer, according to particular embodiments, the core layer provided may have any of the characteristics described herein.

Regarding the second step 420 of forming the first outer layer overlying the first surface of the core layer, according to certain embodiments, the first outer layer may be formed using any known forming method for forming a layer in a multilayer gasket or other components.

According to certain embodiments, the first outer layer may be formed using an extrusion process. As such, according to certain embodiments, a first outer layer as described herein may be referred to as an extruded first outer layer.

According to certain embodiments, the first outer layer may be formed using a skiving process. As such, according to certain embodiments, a first outer layer as described herein may be referred to as a skived first outer layer.

According to certain embodiments, the first outer layer may be formed using a casting process. As such, according to certain embodiments, a first outer layer as described herein may be referred to as a cast first outer layer.

According to certain embodiments, the first outer layer may be formed using a molding process. As such, according to certain embodiments, a first outer layer as described herein may be referred to as a molded first outer layer.

It will be appreciated that where the first outer layer is formed according to any of the processes noted herein, it can further be referred to based on the process by which it is not formed. For example, according to certain embodiments, the first outer layer may not be formed using an extruded process. As such, according to certain embodiments, a first outer layer as described herein may be referred to as a non-extruded first outer layer. According to other embodiments, the first outer layer may not be formed using a skiving process. As such, according to certain embodiments, a first outer layer as described herein may be referred to as a non-skived first outer layer. According to other embodiments, the first outer layer may not be formed using a casting process. As such, according to certain embodiments, a first outer layer as described herein may be referred to as a non-cast first outer layer. According to other embodiments, the first outer layer may not be formed using a molding process. As such, according to certain embodiments, a first outer layer as described herein may be referred to as a non-molded first outer layer. According to still other embodiments, the method 400 may further include a step (not shown) of applying a corona treatment, a plasma treatment or any combination thereof to an inner surface of the first outer layer, an outer surface of the first outer layer or any combination thereof. It will be appreciated that the corona treatment or plasma treatment may be applied according to any known corona treatment application process or plasma treatment application process.

According to still other embodiments, the method 400 may further include a step (not shown) of applying a corona treatment, a plasma treatment or any combination thereof to an inner surface of the first outer layer, an outer surface of the first outer layer or any combination thereof. It will be appreciated that the corona treatment or plasma treatment may be applied according to any known corona treatment application process or plasma treatment application process.

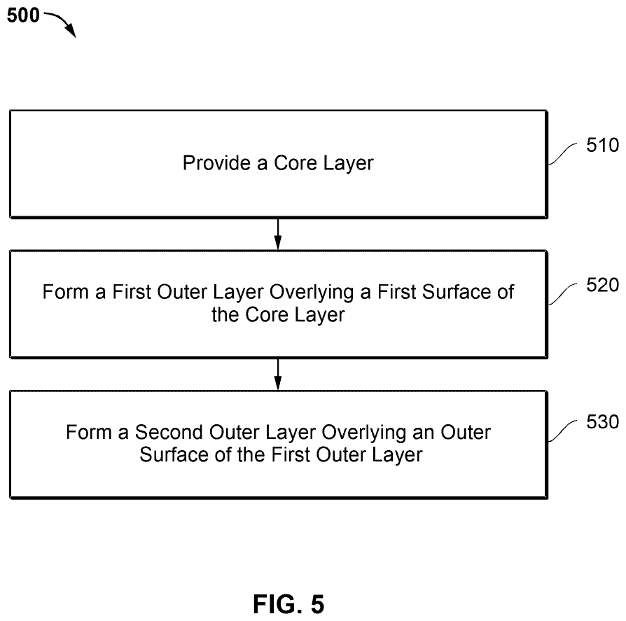

Referring now to a method of forming a multilayer gasket as described herein, FIG. 5 includes a diagram showing a forming method 500 for forming a multilayer gasket according to embodiments described herein. According to particular embodiments, the forming method 500 may include a first step 510 of providing a core layer, a second step 520 of forming a first outer layer overlying a first surface of the core layer, and a third step 530 of forming a second outer layer overlying an outer surface of the first outer layer.

Regarding the first step 510 of providing a core layer, according to particular embodiments, the core layer provided may have any of the characteristics described herein.

Regarding the second step 520 of forming the first outer layer overlying the first surface of the core layer, according to certain embodiments, the first outer layer may be formed using any known forming method for forming a layer in a multilayer gasket or other components.

According to certain embodiments, the first outer layer may be formed using an extrusion process. As such, according to certain embodiments, a first outer layer as described herein may be referred to as an extruded first outer layer.

According to certain embodiments, the first outer layer may be formed using a skiving process. As such, according to certain embodiments, a first outer layer as described herein may be referred to as a skived first outer layer.

According to certain embodiments, the first outer layer may be formed using a casting process. As such, according to certain embodiments, a first outer layer as described herein may be referred to as a cast first outer layer.

According to certain embodiments, the first outer layer may be formed using a molding process. As such, according to certain embodiments, a first outer layer as described herein may be referred to as a molded first outer layer.

It will be appreciated that where the first outer layer is formed according to any of the processes noted herein, it can further be referred to based on the process by which it is not formed. For example, according to certain embodiments, the first outer layer may not be formed using an extruded process. As such, according to certain embodiments, a first outer layer as described herein may be referred to as a non-extruded first outer layer. According to other embodiments, the first outer layer may not be formed using a skiving process. As such, according to certain embodiments, a first outer layer as described herein may be referred to as a non-skived first outer layer. According to other embodiments, the first outer layer may not be formed using a casting process. As such, according to certain embodiments, a first outer layer as described herein may be referred to as a non-cast first outer layer. According to other embodiments, the first outer layer may not be formed using a molding process. As such, according to certain embodiments, a first outer layer as described herein may be referred to as a non-molded first outer layer.

Regarding the second step 520 of forming the second outer layer overlying the outer surface of the first outer layer, according to certain embodiments, the second outer layer may be formed using any known forming method for forming a layer in a multilayer gasket or other components.

According to certain embodiments, the second outer layer may be formed using an extrusion process. As such, according to certain embodiments, a second outer layer as described herein may be referred to as an extruded second outer layer.

According to certain embodiments, the second outer layer may be formed using a skiving process. As such, according to certain embodiments, a second outer layer as described herein may be referred to as a skived second outer layer.

According to certain embodiments, the second outer layer may be formed using a casting process. As such, according to certain embodiments, a second outer layer as described herein may be referred to as a cast second outer layer.

According to certain embodiments, the second outer layer may be formed using a molding process. As such, according to certain embodiments, a second outer layer as described herein may be referred to as a molded second outer layer.

It will be appreciated that where the second outer layer is formed according to any of the processes noted herein, it can further be referred to based on the process by which it is not formed. For example, according to certain embodiments, the second outer layer may not be formed using an extruded process. As such, according to certain embodiments, a second outer layer as described herein may be referred to as a non-extruded second outer layer. According to other embodiments, the second outer layer may not be formed using a skiving process. As such, according to certain embodiments, a second outer layer as described herein may be referred to as a non-skived second outer layer. According to other embodiments, the second outer layer may not be formed using a casting process. As such, according to certain embodiments, a second outer layer as described herein may be referred to as a non-cast second outer layer. According to other embodiments, the second outer layer may not be formed using a molding process. As such, according to certain embodiments, a second outer layer as described herein may be referred to as a non-molded second outer layer.

According to still other embodiments, the method 500 may further include a step (not shown) of applying a corona treatment, a plasma treatment or any combination thereof to an inner surface of the first or second outer layers, an outer surface of the first or second outer layers or any combination thereof. It will be appreciated that the corona treatment or plasma treatment may be applied according to any known corona treatment application process or plasma treatment application process.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A multilayer gasket comprising a core layer; and a first outer layer overlying a first surface of the core layer, wherein the first outer layer comprises a low-melt fluoropolymer material having a melting temperature of not greater than about 300° C.

Embodiment 2. A multilayer gasket comprising a core layer; and a first outer layer overlying a first surface of the core layer, wherein the first outer layer comprises a low-melt fluoropolymer material comprising polyvinylidene fluoride (PVDF) or terpolymer of tetrafluorethylene hexafluorpropylene) or vinylidene fluoride (THV) or ethylene tetrafluoroethylene (ETFE) or ethylene chlorotrifluoroethylene (ECTFE) or fluorinated ethylene propylene (FEP) or perfluoroalkoxy alkane (PFA) or any combination thereof or copolymers thereof.

Embodiment 3. An electrolyzer membrane electrode assembly (MEA) comprising a membrane, an anode, a cathode, and a multilayer gasket, wherein the multilayer gasket comprises: a core layer, and a first outer layer overlying a first surface of the core layer, wherein the first outer layer comprises a low-melt fluoropolymer material having a melting temperature of not greater than about 300° C.

Embodiment 4. An electrolyzer membrane electrode assembly (MEA) comprising a membrane, an anode, a cathode, and a multilayer gasket, wherein the multilayer gasket comprises: a core layer, and a first outer layer overlying a first surface of the core layer, wherein the first outer layer comprises a low-melt fluoropolymer material comprising polyvinylidene fluoride (PVDF) or terpolymer of tetrafluorethylene hexafluorpropylene) or vinylidene fluoride (THV) or ethylene tetrafluoroethylene (ETFE) or ethylene chlorotrifluoroethylene (ECTFE) or fluorinated ethylene propylene (FEP) or perfluoroalkoxy alkane (PFA) or any combination thereof or copolymers thereof.

Embodiment 5. A method of forming a multilayer gasket comprising: providing a core layer; and forming a first outer layer overlying a first surface of the core layer, wherein the first outer layer comprises a low-melt fluoropolymer material having a melting temperature of not greater than about 300° C.

Embodiment 6. A method of forming a multilayer gasket comprising: providing a core layer; and forming a first outer layer overlying a first surface of the core layer, wherein the first outer layer comprises a low-melt fluoropolymer material comprising polyvinylidene fluoride (PVDF) or terpolymer of tetrafluorethylene hexafluorpropylene) or vinylidene fluoride (THV) or ethylene tetrafluoroethylene (ETFE) or ethylene chlorotrifluoroethylene (ECTFE) or fluorinated ethylene propylene (FEP) or perfluoroalkoxy alkane (PFA) or any combination thereof or copolymers thereof.

Embodiment 7. The multilayer gasket, electrolyzer MEA or method of any one of embodiments 1, 2, 3, 4, 5, and 6, wherein the low-melt fluoropolymer material comprises a melting temperature of not greater than about 300° C.

Embodiment 8. The multilayer gasket, electrolyzer MEA or method of any one of embodiments 1, 2, 3, 4, 5, and 6, wherein the low-melt fluoropolymer material comprises polyvinylidene fluoride (PVDF) or terpolymer of tetrafluorethylene hexafluorpropylene) and vinylidene fluoride (THV) or ethylene tetrafluoroethylene (ETFE) or ethylene chlorotrifluoroethylene (ECTFE) or fluorinated ethylene propylene (FEP) or perfluoroalkoxy alkane (PFA) or any combination thereof or copolymers thereof.

Embodiment 9. The multilayer gasket, electrolyzer MEA or method of any one of embodiments 1, 2, 3, 4, 5, and 6, wherein the low-melt fluoropolymer material comprises a fluoropolymer material content of at least about 50 wt. % for a total weight of the low-melt fluoropolymer material.

Embodiment 10. The multilayer gasket, electrolyzer MEA or method of any one of embodiments 1, 2, 3, 4, 5, and 6, wherein the low-melt fluoropolymer material comprises a fluoropolymer material content of not greater than about 100 wt. % for a total weight of the low-melt fluoropolymer material.

Embodiment 11. The multilayer gasket, electrolyzer MEA or method of any one of embodiments 1, 2, 3, 4, 5, and 6, wherein the low-melt fluoropolymer material comprises PVDF.

Embodiment 12. The multilayer gasket, electrolyzer MEA or method of any one of embodiments 1, 2, 3, 4, 5, and 6, wherein the low-melt fluoropolymer material comprises a PVDF content of at least about 50 wt. % for a total weight of the low-melt fluoropolymer material.

Embodiment 13. The multilayer gasket, electrolyzer MEA or method of any one of embodiments 1, 2, 3, 4, 5, and 6, wherein the low-melt fluoropolymer material comprises a PVDF content of not greater than about 100 wt. % for a total weight of the low-melt fluoropolymer material.

Embodiment 14. The multilayer gasket, electrolyzer MEA or method of any one of embodiments 1, 2, 3, 4, 5, and 6, wherein the low-melt fluoropolymer material comprises PVDF-HFP co-polymer.

Embodiment 15. The multilayer gasket, electrolyzer MEA or method of any one of embodiments 1, 2, 3, 4, 5, and 6, wherein the low-melt fluoropolymer material comprises a PVDF-HFP co-polymer content of at least about 50 wt. % for a total weight of the low-melt fluoropolymer material.

Embodiment 16. The multilayer gasket, electrolyzer MEA or method of any one of embodiments 1, 2, 3, 4, 5, and 6, wherein the low-melt fluoropolymer material comprises a PVDF-HFP co-polymer content of not greater than about 100 wt. % for a total weight of the low-melt fluoropolymer material.

Embodiment 17. The multilayer gasket, electrolyzer MEA or method of any one of embodiments 1, 2, 3, 4, 5, and 6, wherein the PVDF-HFP co-polymer comprises a HFP content of at least about 0.5 wt. % for a total weight of the low-melt fluoropolymer material.

Embodiment 18. The multilayer gasket, electrolyzer MEA or method of any one of embodiments 1, 2, 3, 4, 5, and 6, wherein the PVDF-HFP co-polymer comprises a HFP content of not greater than about 50 wt. % for a total weight of the low-melt fluoropolymer material.

Embodiment 19. The multilayer gasket, electrolyzer MEA or method of any one of embodiments 1, 2, 3, 4, 5, and 6, wherein the PVDF-HFP co-polymer comprises a PVDF content of at least about 50 wt. % for a total weight of the low-melt fluoropolymer material.

Embodiment 20. The multilayer gasket, electrolyzer MEA or method of any one of embodiments 1, 2, 3, 4, 5, and 6, wherein the PVDF-HFP co-polymer comprises a PVDF content of not greater than about 99.5 wt. % for a total weight of the low-melt fluoropolymer material.

Embodiment 21. The multilayer gasket, electrolyzer MEA or method of any one of embodiments 1, 3, and 5, wherein an inner surface of the first outer layer adjacent to the first surface of the core layer or an outer surface of the first outer layer opposite of the first surface of the core layer is a corona treated surface, a plasma treated surface or any combination thereof.

Embodiment 22. The multilayer gasket, electrolyzer MEA or method of any one of embodiments 2, 4, 6, and 21, wherein an inner surface of the first outer layer adjacent to the first surface of the core layer is a corona treated surface, a plasma treated surface or any combination thereof.

Embodiment 23. The multilayer gasket, electrolyzer MEA or method of any one of embodiments 2, 4, 6, and 21, wherein an outer surface of the first outer layer opposite of the first surface of the core layer is a corona treated surface, a plasma treated surface or any combination thereof.

Embodiment 24. The multilayer gasket, electrolyzer MEA or method of any one of embodiments 2, 4, 6, and 21, wherein an inner surface of the first outer layer adjacent to the first surface of the core layer and an outer surface of the first outer layer opposite of the first surface of the core layer is a corona treated surface, a plasma treated surface or any combination thereof.

Embodiment 25. The multilayer gasket, electrolyzer MEA or method of any one of embodiments 1, 2, 3, 4, 5, and 6, wherein the outer surface of the first outer layer opposite of the first surface of the core layer has an adhesion strength of at least 0.1 lb./in.

Embodiment 26. The multilayer gasket, electrolyzer MEA or method of any one of embodiments 1, 2, 3, 4, 5, and 6, wherein the outer surface of the first outer layer opposite of the first surface of the core layer has an adhesion strength of not greater than about 10 lb./in.

Embodiment 27. The multilayer gasket, electrolyzer MEA or method of any one of embodiments 1, 2, 3, 4, 5, and 6, wherein the outer surface of the first outer layer opposite of the first surface of the core layer has a surface energy of at least about 1.0 mJ/m².

Embodiment 28. The multilayer gasket, electrolyzer MEA or method of any one of embodiments 1, 2, 3, 4, 5, and 6, wherein the outer surface of the first outer layer opposite of the first surface of the core layer has a surface energy of not greater than about 100.0 mJ/m².

Embodiment 29. The multilayer gasket, electrolyzer MEA or method of any one of embodiments 1, 2, 3, 4, 5, and 6, wherein the outer surface of the first outer layer opposite of the first surface of the core layer has a water contact angle of at least about 1 degree.

Embodiment 30. The multilayer gasket, electrolyzer MEA or method of any one of embodiments 1, 2, 3, 4, 5, and 6, wherein the outer surface of the first outer layer opposite of the first surface of the core layer has a water contact angle of not greater than about 150 degrees.

Embodiment 31. The multilayer gasket, electrolyzer MEA or method of any one of embodiments 1, 2, 3, 4, 5, and 6, wherein the outer surface of the first outer layer opposite of the first surface of the core layer has a surface roughness of at least about 0.01 micron when measured using a long wavelength cutoff of 800 microns.

Embodiment 32. The multilayer gasket, electrolyzer MEA or method of any one of embodiments 1, 2, 3, 4, 5, and 6, wherein the outer surface of the first outer layer opposite of the first surface of the core layer has a surface roughness of not greater than about 5.0 micron when measured using a long wavelength cutoff of 800 microns.

Embodiment 33. The multilayer gasket, electrolyzer MEA or method of any one of embodiments 1, 2, 3, 4, 5, and 6, wherein the core layer comprises a core material selected from the group consisting of a polyimide (PI), polyethylenimine (PEI), polyphenylene sulfide (PPS), polysulfone (PSU), polyethersulfone (PES), polyetherketone (PEEK), polyphenylsulfone (PPSU), polyamide-imide (PAI), polybenzimidazole (PBI), polytetrafluoroethylene (PTFE), polyamide (PA), polycarbonate (PC), polyethylene terephthalate (PET), polyurethane (PUR), and any combination thereof.

Embodiment 34. The multilayer gasket, electrolyzer MEA or method of embodiment 33, wherein the core layer comprises a core material content of at least about 50 wt. % for a total weight of the core layer.

Embodiment 35. The multilayer gasket, electrolyzer MEA or method of embodiment 33, wherein the core layer comprises a core material content of not greater than about 100 wt. % for a total weight of the core layer.

Embodiment 36. The multilayer gasket, electrolyzer MEA or method of embodiment 33, wherein the core layer consists of a core material.

Embodiment 37. The multilayer gasket, electrolyzer MEA or method of embodiment 33, wherein the core layer comprises a polyimide (PI).

Embodiment 38. The multilayer gasket, electrolyzer MEA or method of embodiment 37, wherein the core layer comprises a polyimide material content of at least about 50 wt. % for a total weight of the core layer.

Embodiment 39. The multilayer gasket, electrolyzer MEA or method of embodiment 37, wherein the core layer comprises a polyimide material content of not greater than about 100 wt. % for a total weight of the core layer.

Embodiment 40. The multilayer gasket, electrolyzer MEA or method of any one of embodiments 1, 2, 3, 4, 5, and 6, wherein the core layer consists of a polyimide material.

Embodiment 41. The multilayer gasket, electrolyzer MEA or method of any one of embodiments 1, 2, 3, 4, 5, and 6, wherein the first outer layer comprises a fluoropolymer material content of at least about 50 wt. % for a total weight of the first outer layer.

Embodiment 42. The multilayer gasket, electrolyzer MEA or method of any one of embodiments 1, 2, 3, 4, 5, and 6, wherein the first outer layer comprises a fluoropolymer material content of not greater than about 100 wt. % for a total weight of the first outer layer.

Embodiment 43. The multilayer gasket, electrolyzer MEA or method of any one of embodiments 1, 2, 3, 4, 5, and 6, wherein the first outer layer consists of a fluoropolymer material.

Embodiment 44. The multilayer gasket, electrolyzer MEA or method of any one of embodiments 1, 2, 3, 4, 5, and 6, wherein the fluoropolymer material is selected from the group consisting of polytetrafluoroethylene (PTFE), fluorinated ethylene propylene (FEP), perfluoroalkoxy (PFA), polyvinyl fluoride (PVF), polyvinylidene fluoride (PVDF), ethylene tetrafluoroethylene (ETFE), ethylene chlorotrifluoroethylene (ECTFE), polychlorotrifluoroethylene (PCTFE), polychlorotrifluoroethylene (PFPE), tetrafluoroethylene (TFE), hexafluoropropylene (HFP), modified PTFE, copolymers thereof, and any combination thereof.

Embodiment 45. The multilayer gasket, electrolyzer MEA or method of any one of embodiments 1, 2, 3, 4, 5, and 6, wherein the core layer comprises a thickness of at least about 10 microns.

Embodiment 46. The multilayer gasket, electrolyzer MEA or method of any one of embodiments 1, 2, 3, 4, 5, and 6, wherein the core layer comprises a thickness of not greater than about 3000 microns.

Embodiment 47. The multilayer gasket, electrolyzer MEA or method of any one of embodiments 1, 2, 3, 4, 5, and 6, wherein the first outer layer comprises a thickness of at least about 0.1 microns.

Embodiment 48. The multilayer gasket, electrolyzer MEA or method of any one of embodiments 1, 2, 3, 4, 5, and 6, wherein the first outer layer comprises a thickness of not greater than about 200 microns.

Embodiment 49. The multilayer gasket, electrolyzer MEA or method of any one of embodiments 1, 2, 3, 4, 5, and 6, wherein the multilayer gasket further comprises a second outer layer overlying the outer surface of the first outer layer.

Embodiment 50. The multilayer gasket, electrolyzer MEA or method of embodiment 49, wherein an outer surface of the second outer layer opposite of the outer surface of the first outer layer is a corona treated surface, a plasma treated surface or any combination thereof.

Embodiment 51. The multilayer gasket, electrolyzer MEA or method of embodiment 49, wherein an outer surface of the second outer layer opposite of the outer surface of the first outer layer has an adhesion strength of at least 0.1 lb./in.

Embodiment 52. The multilayer gasket, electrolyzer MEA or method of embodiment 49, wherein an outer surface of the second outer layer opposite of the outer surface of the first outer layer has an adhesion strength of not greater than about 10 lb./in.

Embodiment 53. The multilayer gasket, electrolyzer MEA or method of embodiment 49, wherein an outer surface of the second outer layer opposite of the outer surface of the first outer layer has a surface energy of at least about 1.0 mJ/m².

Embodiment 54. The multilayer gasket, electrolyzer MEA or method of embodiment 49, wherein an outer surface of the second outer layer opposite of the outer surface of the first outer layer has a surface energy of not greater than about 100.0 mJ/m².

Embodiment 55. The multilayer gasket, electrolyzer MEA or method of embodiment 49, wherein an outer surface of the second outer layer opposite of the outer surface of the first outer layer has a water contact angle of at least about 1 degree.

Embodiment 56. The multilayer gasket, electrolyzer MEA or method of embodiment 49, wherein an outer surface of the second outer layer opposite of the outer surface of the first outer layer has a water contact angle of not greater than about 150 degrees.

Embodiment 57. The multilayer gasket, electrolyzer MEA or method of embodiment 49, wherein the second outer layer comprises a fluoropolymer material content of at least about 50 wt. % for a total weight of the second outer layer.

Embodiment 58. The multilayer gasket, electrolyzer MEA or method of embodiment 49, wherein the second outer layer comprises a fluoropolymer material content of not greater than about 100 wt. % for a total weight of the second outer layer.

Embodiment 59. The multilayer gasket, electrolyzer MEA or method of any one of embodiments 1, 2, 3, 4, 5, and 6, wherein the second outer layer consists of a fluoropolymer material.

Embodiment 60. The multilayer gasket, electrolyzer MEA or method of any one of embodiments 1, 2, 3, 4, 5, and 6, wherein the outer surface of the second outer layer opposite of the outer surface of the first outer layer has a surface roughness of at least about 0.01 micron when measured using a long wavelength cutoff of 800 microns.

Embodiment 61. The multilayer gasket, electrolyzer MEA or method of any one of embodiments 1, 2, 3, 4, 5, and 6, wherein the outer surface of the second outer layer opposite of the outer surface of the first outer layer has a surface roughness of not greater than about 5.0 micron when measured using a long wavelength cutoff of 800 microns.

Embodiment 62. The multilayer gasket, electrolyzer MEA or method of embodiment 49, wherein the fluoropolymer material comprises is selected from the group consisting of polytetrafluoroethylene (PTFE), fluorinated ethylene propylene (FEP), perfluoroalkoxy (PFA), polyvinyl fluoride (PVF), polyvinylidene fluoride (PVDF), ethylene tetrafluoroethylene (ETFE), ethylene chlorotrifluoroethylene (ECTFE), polychlorotrifluoroethylene (PCTFE), polychlorotrifluoroethylene (PFPE), tetrafluoroethylene (TFE), hexafluoropropylene (HFP), modified PTFE, copolymers thereof, and any combination thereof.

Embodiment 63. The multilayer gasket, electrolyzer MEA or method of embodiment 49, wherein the core layer comprises a thickness of at least about 10 microns.

Embodiment 64. The multilayer gasket, electrolyzer MEA or method of embodiment 49, wherein the core layer comprises a thickness of not greater than about 3000 microns.

Embodiment 65. The multilayer gasket, electrolyzer MEA or method of embodiment 49, wherein the second outer layer comprises a thickness of at least about 0.1 microns.

Embodiment 66. The multilayer gasket, electrolyzer MEA or method of embodiment 49, wherein the second outer layer comprises a thickness of not greater than about 200 microns.

Embodiment 67. The multilayer gasket, electrolyzer MEA or method of any one of embodiments 1, 2, 3, 4, 5, and 6, wherein the gasket comprises a thickness of at least about 10.2 microns.

Embodiment 68. The multilayer gasket, electrolyzer MEA or method of any one of embodiments 1, 2, 3, 4, 5, and 6, wherein the gasket comprises a thickness of not greater than about 3400 microns.

Embodiment 69. The multilayer gasket, electrolyzer MEA or method of any one of embodiments 1, 2, 3, 4, 5, and 6, wherein the gasket comprises a elastic modulus of at least about 0.1 GPa.

Embodiment 70. The multilayer gasket, electrolyzer MEA or method of any one of embodiments 1, 2, 3, 4, 5, and 6, wherein the gasket comprises a elastic modulus of not greater than about 10 GPa.

Embodiment 71. The electrolyzer MEA of embodiments 3, and 4, wherein the membrane comprises Nafion, Zirfon, Pemion, Aemion, sulfonated tetrafluoroethylene, polysulfone, sulfonated polyimide (SPI), polybenzimidazole (PBI), polystyrene, polyphosphazene, sulfonated poly (arylene ether ketone) (SPAEK), sulfonated poly (ether ether ketone) (SPEEK), sulfonated poly (arylene sulfone) (SPAS), sulfonated poly (arylene ether nitrile) (SPEN), copolymers thereof, blends thereof, and other ionically-conductive materials.

Embodiment 72. The electrolyzer MEA of embodiments 3, and 4, wherein the membrane comprises a thickness of at least about 1 micron.

Embodiment 73. The electrolyzer MEA of embodiments 3, and 4, wherein the membrane comprises a thickness of not greater than about 500 microns.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A multilayer gasket comprising a core layer; and a first outer layer overlying a first surface of the core layer, wherein the first outer layer comprises a low-melt fluoropolymer material having a melting temperature of not greater than about 300° C.

2. The multilayer gasket claim 1, wherein the low-melt fluoropolymer material comprises a fluoropolymer material content of at least about 50 wt. % for a total weight of the low-melt fluoropolymer material.

3. The multilayer gasket claim 1, wherein the low-melt fluoropolymer material comprises a fluoropolymer material content of not greater than about 100 wt. % for a total weight of the low-melt fluoropolymer material.

4. The multilayer gasket claim 1, wherein the low-melt fluoropolymer material comprises PVDF.

5. The multilayer gasket claim 1, wherein the low-melt fluoropolymer material comprises PVDF-HFP co-polymer.

6. The multilayer gasket claim 1, wherein an inner surface of the first outer layer adjacent to the first surface of the core layer or an outer surface of the first outer layer opposite of the first surface of the core layer is a corona treated surface, a plasma treated surface or any combination thereof.

7. The multilayer gasket claim 1, wherein an outer surface of the first outer layer opposite of the first surface of the core layer is a corona treated surface, a plasma treated surface or any combination thereof.

8. The multilayer gasket claim 1, wherein the outer surface of the first outer layer opposite of the first surface of the core layer has an adhesion strength of at least 0.1 lb./in.

9. The multilayer gasket claim 1, wherein the outer surface of the first outer layer opposite of the first surface of the core layer has an adhesion strength of not greater than about 10 lb./in.

10. The multilayer gasket claim 1, wherein the outer surface of the first outer layer opposite of the first surface of the core layer has a surface energy of at least about 1.0 mJ/m².

11. The multilayer gasket claim 1, wherein the outer surface of the first outer layer opposite of the first surface of the core layer has a surface energy of not greater than about 100.0 mJ/m².

12. The multilayer gasket claim 1, wherein the outer surface of the first outer layer opposite of the first surface of the core layer has a water contact angle of at least about 1 degree.

13. The multilayer gasket claim 1, wherein the outer surface of the first outer layer opposite of the first surface of the core layer has a water contact angle of not greater than about 150 degrees.

14. A multilayer gasket comprising a core layer; and a first outer layer overlying a first surface of the core layer, wherein the first outer layer comprises a low-melt fluoropolymer material comprising polyvinylidene fluoride (PVDF) or terpolymer of tetrafluorethylene hexafluorpropylene) or vinylidene fluoride (THV) or ethylene tetrafluoroethylene (ETFE) or ethylene chlorotrifluoroethylene (ECTFE) or fluorinated ethylene propylene (FEP) or perfluoroalkoxy alkane (PFA) or any combination thereof or copolymers thereof.

15. The multilayer gasket claim 14, wherein the low-melt fluoropolymer material comprises a fluoropolymer material content of at least about 50 wt. % for a total weight of the low-melt fluoropolymer material.

16. The multilayer gasket claim 14, wherein the low-melt fluoropolymer material comprises a fluoropolymer material content of not greater than about 100 wt. % for a total weight of the low-melt fluoropolymer material.

17. The multilayer gasket claim 14, wherein the low-melt fluoropolymer material comprises PVDF.

18. The multilayer gasket claim 14, wherein the low-melt fluoropolymer material comprises PVDF-HFP co-polymer.

19. The multilayer gasket claim 14, wherein an inner surface of the first outer layer adjacent to the first surface of the core layer or an outer surface of the first outer layer opposite of the first surface of the core layer is a corona treated surface, a plasma treated surface or any combination thereof.

20. A method of forming a multilayer gasket comprising:
providing a core layer; and
forming a first outer layer overlying a first surface of the core layer,
wherein the first outer layer comprises a low-melt fluoropolymer material having a melting temperature of not greater than about 300° C.
